(19) United States
(12) Patent Application Publication
(10) Pub. No.: US 2008/0198098 A1
(43) Pub. Date: Aug. 21, 2008

(54) Electronic sign

(75) Inventors: Alexander Gelbman, Florham Park, NJ (US); Edward Holcomb, Needham, MA (US); Christopher Turner, Needham, MA (US); Martin Wells, Needham, MA (US)

Correspondence Address: LAHIVE & COCKFIELD, LLP, ONE POST OFFICE SQUARE, BOSTON, MA, 02109, US

(73) Assignee: Metrologic Instruments, Inc., Blackwood, NJ (US)

(21) Appl. No.: 11/975,987

(22) Filed: Oct. 22, 2007

Related U.S. Application Data
(60) Provisional application No. 60/853,345, filed on Oct. 21, 2006.
(60) Provisional application No. 60/880,190, filed on Jan. 12, 2007.

(51) Int. Cl. H04L 12/28; G09G 3/20

(52) U.S. Cl. 345/59; 370/406

(57) ABSTRACT

An electronic sign employs a bi-stable, non-volatile display material activatable by electrodes to convey information. A sensor detects when the electronic sign is inserted in or in the vicinity of an insertion area, and controls the operation of the sign based on the detected location. A backplane in the electronic sign includes different patterns of addressable elements to provide a display that pixel, font region, or icon addressable or have a combination of one or more of the pixel, font region, or icon addressability. A remote device communicates with the electronic sign, and multiple electronic signs may communicate with each other via a communication protocol, such as mesh networking.

### RELATED APPLICATIONS

The current application claims priority to related U.S. Provisional Application Ser. No. 60/853,345, filed on Oct. 21, 2006 and U.S. Provisional Application Ser. No. 60/880,190, filed on Jan. 12, 2007. The disclosures of said Applications are hereby incorporated by reference in its entirety.

### BACKGROUND OF THE INVENTION

Conventionally, sign cards are used to convey information relating to objects located in the area of the sign cards, for example, in the field of retail. Such sign cards are typical composed of paper, cardboard or plastic. One category of sign cards typically includes predefined text or numbers for permanently representing the text or numbers to be shown on that sign. Other sign holders known in the art allow customers to print out all types of information (prices, sales. promotions, specials, etc.) on paper or cardboard, which they then insert in the appropriate holder, frame or merchandizing fixture. These conventional sign cards or signs typically do not have an electronic circuitry. When a user desires to change the information represented by the sign to something else, the user must manually change the sign cards or sheet of paper to convey the new information that the sign displays.

Several types of sign cards are known in the prior art. For example, FIG. 1 depicts a general prior art system of sign cards 10a-10z that are connected using a spiral binding 11. Each sign card 10 can permanently represent predetermined numbers or text 13. These spiral bound flip charts 10a-10z contain units of measure, quantities and currency, as well as characters and icons. FIG. 2 depicts a series of single width sign cards 10a-d that can be inserted into a slide channel board. The single width sign cards 10a-10d can also include permanent predetermined units of measure, quantities and currency as well as characters, icons and other information 13. FIG. 3 depicts another conventional configuration of a sign card 10 that may be configured to fit into a predetermined location. Sign cards 10 can have tabs 12 located on the top and/or bottom of the sign cards, as shown, or can have tabs on the sides. The tabs 12 are used to fit these sign cards into the predetermined locations.

FIG. 4 depicts a slide channel board 15 that may hold the sign cards, such as the sign cards depicted in FIGS. 1, 2 and 3. The sign cards 10 can be inserted into the slide channel board 15 by sliding the card into and along the channel 16. The illustrative channel is formed by two corresponding channel pieces 16a, 16b, which form a top and a bottom of the channel 16, respectively. When the sign cards are inserted into the slide channel board, they may convey information.

When it is desired that the information being conveyed be changed, the user must manually remove the sign cards and replace them with different sign cards that convey the desired information. In some cases, the user must flip to the new sheet. The cards must then be inserted in the proper order. For example, users insert the desired numbers, characters, special characters, icons, and/or messages into or onto the sign board in the desired sequence. This results in the desired price and/or marketing message being available for the customer to see. These are all labor intensive, error-prone steps.

### SUMMARY OF THE INVENTION

The present invention provides an electronic sign or sign card that employs a bi-stable display material activatable by electrodes to convey information. The electronic sign may be updatable and replace paper, cardboard or plastic sign boards of the prior art. The electronic sign may include a sensor to detect when the electronic sign is inserted in or in the vicinity of an insertion area, and control the operation of the sign based on the detected location. The electronic sign may also be pixel, font region, or icon addressable or have a combination of one or more of the pixel, font region, or icon addressability. The electronic sign may communicate with a remote device and/or other electronic signs via a communication protocol, preferably a wireless communication protocol, such as mesh networking. 8.02.11, TCPIP (Internet Protocol), RFID, or any other Radio Frequency or optical (infra red) protocols.

According to one aspect of the invention, an electronic display system suitable for displaying information is provided. The system comprises a first electrode, a second electrode, a bi-stable display medium between the first electrode and the second electrode and a physical set of related font regions associated with the first and second electrodes for providing a selected type face at a selected size. Each font region member of the physical set is addressable via at least one of the first or second electrodes to activate the bi-stable display medium to display a glyph defined by the addressable related font region members in the physical set.

According to one aspect of the present invention, a backplane for an electronic sign is disclosed. The backplane includes a first layer containing a first pattern of addressable elements and a second layer containing a second pattern of addressable elements. The first layer and second layer are stacked together, such that the first pattern overlays the second pattern.

According to another aspect of the present invention, a system for displaying information is disclosed. The system includes a first electronic sign comprising an electrode layer, a backplane containing a pattern of addressable elements, a bi-stable display medium between the backplane and electrode layer and a processor. The system includes a second electronic sign comprising an electrode layer, a backplane containing a pattern of addressable elements, a bi-stable display medium between the backplane and electrode layer and a processor. The first electronic sign communicates with the second electronic sign.

According to one aspect of the invention, a method of updating information displayed on an electronic sign is disclosed. Performance of the method provides a plurality of electronic signs in at least one store and displays information with the plurality of electronic signs. Performance of the method updates at least a subset of the plurality of electronic signs in the at least one store to change information displayed on the subset of signs. Each of the subset signs includes a unique identifier. The updating is performed remotely to the subset of signs and being based on the identification of at least one of the signs in the subset.

### BRIEF DESCRIPTION OF THE DRAWINGS

The foregoing and other objects, features and advantages of the invention will be apparent from the following description and apparent from the accompanying drawings. The drawings illustrate principles of the invention and, although not to scale, show somewhat relative dimensions.

FIG. 1 depicts a conventional spiral bound price display of the prior art.

FIG. 2 depicts conventional single width inserts of the prior art showing single digits and pre-defined messages.

FIG. 3 depicts another conventional form factor for convention inserts in the prior art.

FIG. 4 depicts a channel sign board used for holding sign cards in the prior art.

FIG. 5A is an exploded schematic view illustrating the composition of one embodiment an electronic sign or label according to the teachings of the present invention.

FIGS. 5B and 5C illustrate two additional embodiments of the electronic sign or label of an embodiment of the invention.

FIGS. 6A and 6B illustrate an electronic sign including a Radio Frequency Identification (RFID) layer.

FIG. 7 illustrates an embodiment of the electronic sign or label of the present invention employing a number of stacked layers.

FIG. 8 illustrates a system for electronically displaying information of a tracked item using a transceiver module and an electronic sign or label according to one embodiment of the invention

FIG. 9 illustrates an embodiment of an electronic display associated with an electronic sign or label according to one embodiment of the invention.

FIG. 10 illustrate the electronic sign or label when used in conjunction with an RFID tag.

FIG. 11 illustrates the electronic sign or label when used in conjunction with a RFID tag.

FIG. 12 shows an illustrative example of machine readable data that can be displayed on an electronic display associated with an electronic sign or label of an embodiment of the invention.

FIG. 13 shows another illustrative example of machine readable data that can be displayed on an electronic display associated with an electronic sign or label of an embodiment of the invention.

FIG. 14 illustrates another embodiment of an electronic sign or label including four regions for displaying a visual indicator simultaneously or sequentially in accordance with the teachings of the present invention.

FIG. 15 illustrates another embodiment of an electronic sign or label in accordance with the teachings of the present invention when used as an indicator of a state of the electronic sign or label.

FIG. 16 illustrates an electronic sign or label of the present invention when used as a read indicator.

FIG. 17 is a flow diagram which illustrates a method of marking an item in accordance with an embodiment of the present invention.

FIG. 18 is a flow diagram which illustrates a method for tracking an item in accordance with another embodiment of the present invention.

FIG. 19 illustrates an electronic sign or label of an embodiment of the present invention when used in conjunction with a shipping container.

FIG. 20 illustrates and electronic sign or label of an embodiment of the present invention when used in conjunction with a pallet.

FIG. 21 illustrates and electronic sign or label of an embodiment of the present invention when used in conjunction with a shipping case.

FIG. 22 illustrates and electronic sign or label of an embodiment of the present invention when used in conjunction with a consumer good.

FIG. 23 illustrates and electronic sign or label of an embodiment of the present invention when used in conjunction with a perishable product.

FIG. 24 illustrates and electronic sign or label of an embodiment of the present invention when used as a seasonal indicator.

FIG. 25 illustrates an electronic sign or label of an embodiment of the present invention when used in conjunction with a package to indicate package priority.

FIG. 26 illustrates an electronic sign or label of an embodiment of the present invention when used in conjunction with a package to indicate package routing information.

FIG. 27 illustrates an electronic sign or label of an embodiment of the present invention when used in conjunction with luggage as a security check indicator.

FIG. 28 illustrates an electronic sign or label of an embodiment of the present invention when used in conjunction with an employee badge.

FIG. 29 illustrates an electronic sign or label of an illustrative embodiment of the present invention when used as a bio-presence sensor.

FIG. 30 illustrates an electronic sign or label of an illustrative embodiment of the present invention when used as a chemical presence sensor.

FIG. 31 illustrates an electronic sign or label of an illustrative embodiment of the present invention when used as an environmental indicator.

FIG. 32 illustrates an electronic sign or label of an illustrative embodiment of the present invention when used as an access control indicator in an access control setting.

FIG. 33 illustrates electronic sign or labels of a present invention when used as part of a pick to light warehouse automation system.

FIG. 34 depicts an illustrative backplane an exemplary configuration having a physical set of related font regions for an electronic that enables creating numbers glyphs having a selected typeface at a selected size and/or a selected style.

FIG. 35 shows a backplane of an electronic sign including multiple layers, where each layer provides a different pre-defined message, respectively, outlining or filled represented by a unique electrode.

FIG. 36 shows a single layered backplane for an electronic sign in which multiple messages are available for addressing and thereby displaying, according to still another embodiment of the invention.

FIG. 37 shows an example of a prior art electronic sign having pixel addressability.

FIG. 38 shows an example of a prior art electronic sign having pixel addressability.

FIG. 39 shows an example of a prior art seven segment backplane of an electronic sign capable of creating individual digits.

FIG. 40 represents an addressable backplane having traditional row/column addressing.

FIG. 41 represents an addressable backplane where each point has only a single point electrode.

FIGS. 42A-42D show a radius and arc pixel, all points addressing scheme which can be used for electronic sign application or any display application.

FIG. 43 illustrates an electronic sign of an illustrative embodiment of the invention having holes to facilitate hanging the electronic sign.

FIG. 44 shows the back of an exemplary electronic sign prior to sliding the electronic sign into the channel of a sign board.

FIG. 45 illustrates a backplane layer substrate and the display medium substrate for an illustrative electronic sign manufactured from one layer that is bent or folded over.

FIG. 46 shows an electronic sign about to be inserted into a channel a sign board according to one embodiment of the invention.

FIG. 47 shows an electronic sign of an illustrative embodiment of the invention after it has been inserted in a channel.

FIG. 48 depicts an electronic sign having a polygon shape.

FIG. 49 shows an electronic sign placed inside a frame and advertising pens.

FIG. 50A shows a single character wide electronic sign displaying information that comprises a single digit according to one embodiment of the invention.

FIG. 50B shows an electronic sign with multiple digits on a single electronic sign according to one embodiment of the invention

FIG. 51 is a functional block diagram showing components of an illustrative electronic sign system.

FIG. 52 depicts a picture of a front side of an exemplary embodiment of an electronic sign insert.

FIG. 53 depicts another picture of a front side of an exemplary embodiment of an electronic sign insert.

FIG. 54 depicts a picture of a backside of an exemplary embodiment of an electronic sign insert.

FIG. 55 is an exemplary flow diagram for illustrating displaying information with an electronic sign insert described herein.

### DESCRIPTION OF EXEMPLARY EMBODIMENTS

The present invention provides an electronic sign that may be used to convey information. The term “electronic sign” also includes an electronic sign card. The invention will be described relative to certain illustrative embodiments. The electronic sign may be updatable and replace paper, cardboard or plastic sign boards of the prior art. The electronic sign may include a sensor to detect when the electronic sign is inserted in or in the vicinity of an insertion area, and control the operation of the sign based on the detected location. The electronic sign may also be pixel, font region, or icon addressable or have a combination of one or more of the pixel, font region, or icon addressability. The electronic sign may communicate with a remote device and/or other electronic signs via a communication protocol, such as mesh networking. Those skilled in the art will recognize that the invention is not limited to the illustrative embodiments, and that variations may be made.

A “glyph”, as used herein, refers to a representation that is displayed on the electronic sign insert of the present invention that has a selected type face at a selected size and a selected style. The term “glyph” refers to the actual shape/size and overall appearance of a character image. A glyph can represent numbers, letters, canned messages or any other symbols or shapes, such as a dollar sign (“$”), a number sign (“#”), a decimal, a punctuation, an arrow, and so on. For example, an italic “A” and a roman “A” are two different glyphs representing the same underlying character.

A “typeface”, as used herein, refers to a set of glyphs with a similar set of appearance characteristics. For example, a typeface may refer to particular fonts, such as Helvetica, Courier New, Arial, Times New Roman, and others known in the art.

A “style”, as used herein, refers to a typeface that may be altered. Such alterations may provide glyphs with a form of emphasis or distinguishing characteristics from other glyphs of a typeface. A style can be, for example, bold, italics, underlining, etc.

A “font region”, as used herein, refers to a region or a portion of a plurality of regions in a backplane of an electronic sign that enables creating glyphs having a selected typeface at a selected size and/or a selected style. A font region is different from a pixel, segment or icon in that the font region represents at least a portion of a typeface for a particular character.

As used herein, relative to manufacturing processes, the term “printed” is meant not to be limited to a printer. Rather, the term “printed” encompasses/includes any method, manner or device used to apply any flowing or soft material, such as a liquid, paste, slurry, gel, and the like, onto a substrate, on top of other material, or components.

As used herein, relative to manufacturing processes, the term deposition is meant not to be limited to a one method/process. Rather, the term “deposition” encompasses/includes any method, manner or device used to apply any gaseous or vapor material onto a substrate, on top of other material, or components.

As used herein, relative to manufacturing processes, the term insert is meant not to be limited to a one method/process. Rather, the term “insert” encompasses/includes any method, manner or device used to attach and/or connect a physical device or component onto a substrate, on top of other material, or to other components or devices.

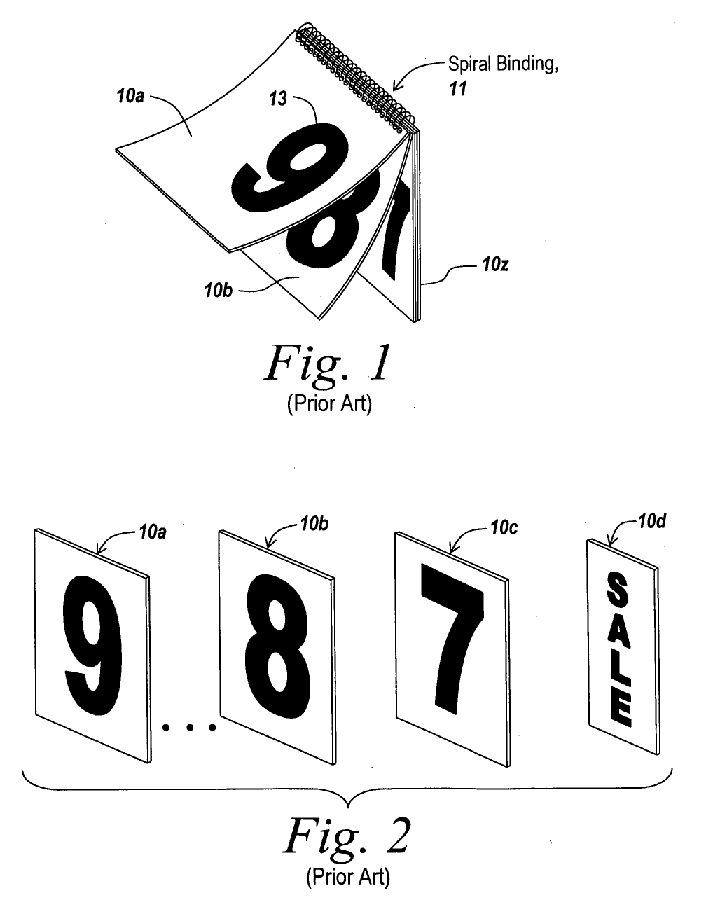

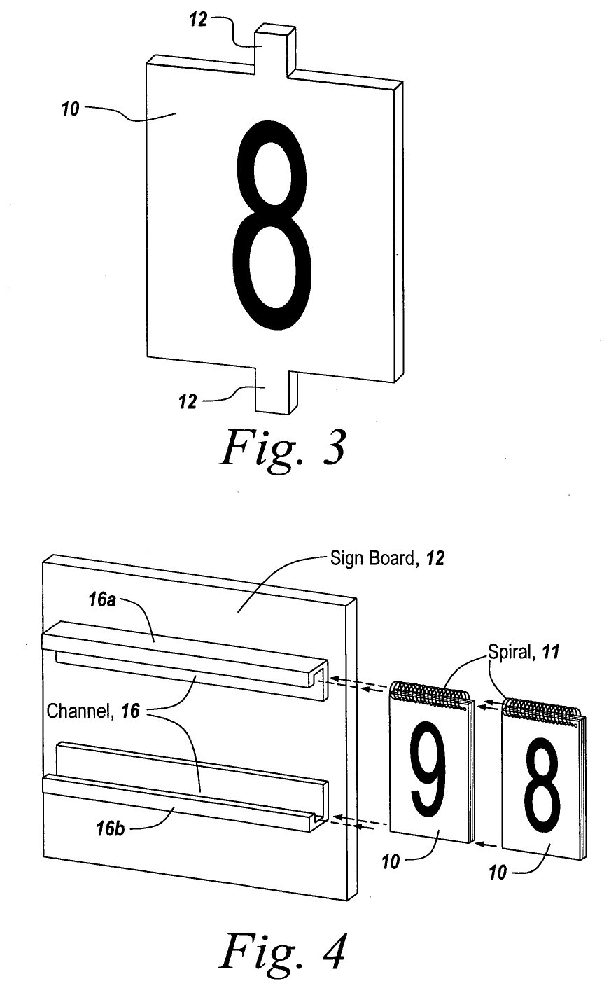

Exemplary embodiments of the present invention provide an electronic sign (ES) for conveying information. Such an electronic sign can be, for example, an electronic sign board insert that is insertable into a sign holder, such as a slide channel board 15 shown in FIG. 4. For example, the electronic sign can be used to replace or can be used in conjunction with existing conventional paper, cardboard, or plastic sign board inserts, such as those depicted in FIGS. 1-3.

The electronic sign of the illustrative embodiments of the invention can be composed of multiple layers of substrate and can have a thin and/or malleable profile such that the electronic insert signs fit into previously determined insert areas. For example, the electronic sign may comprise a substrate/layer on which a display medium is placed. In another embodiment, the electronic sign may comprise a display element, a processor, an antenna element, transceiver, transmitter, receiver, an optional power source or power receiver or power converter, a backplane and/or a storage element arranged in any suitable configuration, as described in U.S. Pat. Nos. 6,753,830 and 6,924,781, incorporated herein by reference. The electronic sign may be used in connection with an activator module. The activator module, when used in connection with the electronic label or sign, can function as a master controller, by sending signals to the electronic label or sign so as to actuate the label or sign to display particular indicia, or by receiving selected signals from the electronic label or sign for subsequent use. Individual electronic signs can serve as activator modules for other electronic signs. Electronic signs are capable of transmitting their unique identifiers in response to a request or periodically on their own.

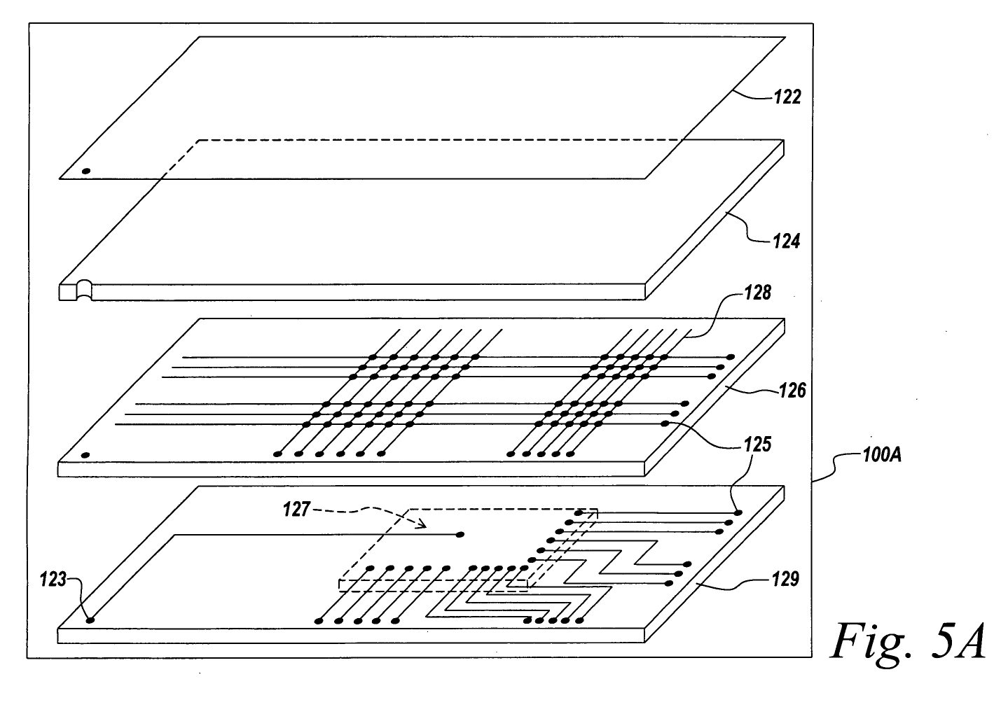

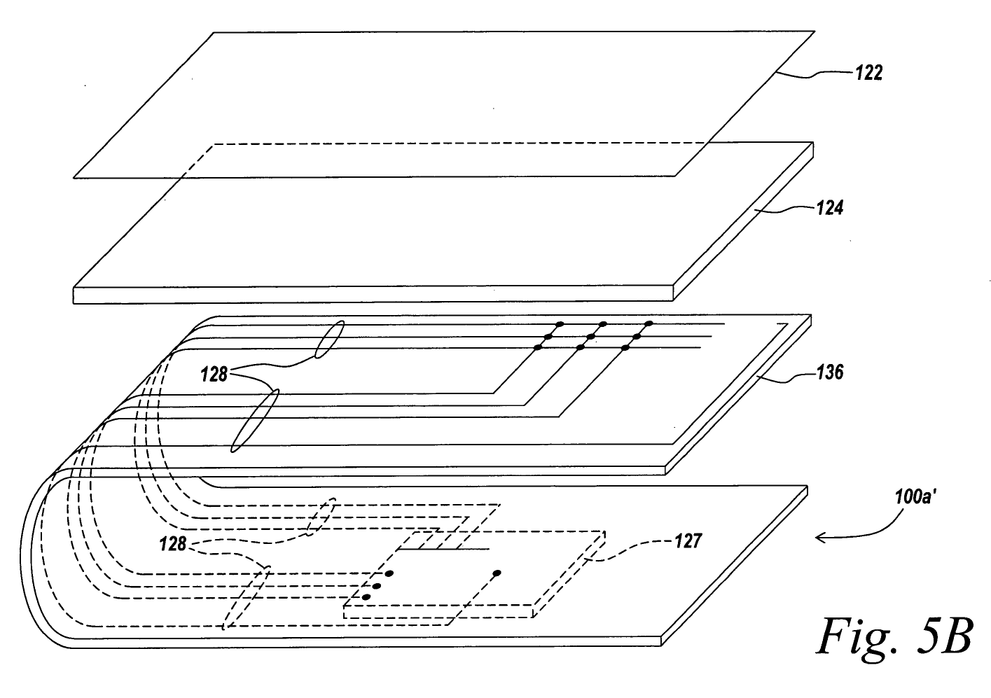

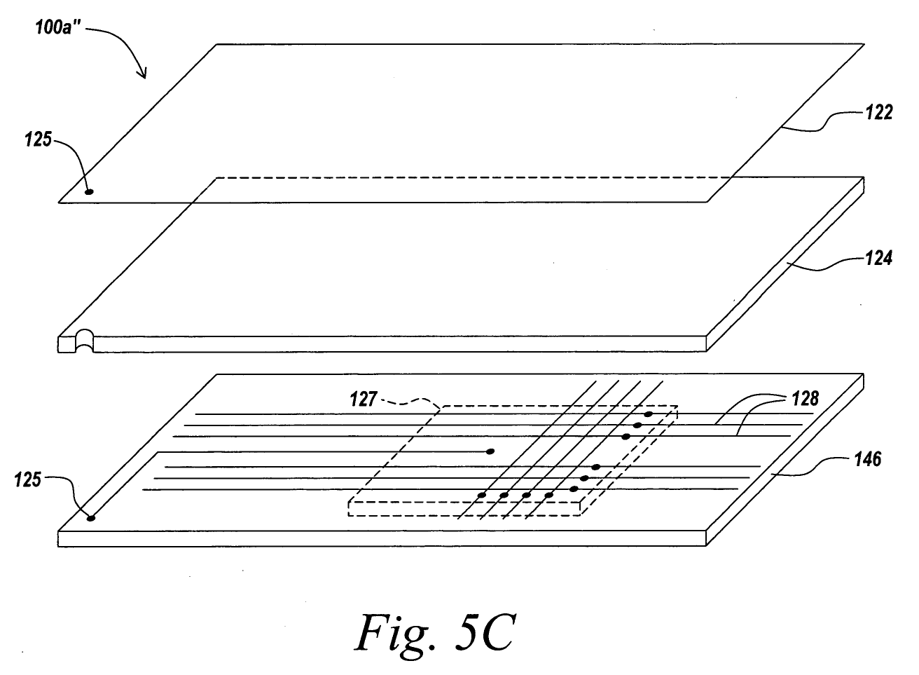

FIG. 5A is an exploded schematic view illustrating the composition of one embodiment an electronic sign or label 100a according to the teachings of the present invention. As shown in FIG. 5A, an illustrative electronic sign 100a of one embodiment of the invention employs a reference electrode layer 122 used in conjunction with electronic ink disposed upon a display medium 124, a backplane 126, and an electronics layer 129 to form an electronically activatable and addressable electronic display 141. The backplane 126 may be made up of one or more layers inter-connected by vias. The illustrative electronics layer 129 can include an electronics module 127, as described in detail below.

Still referring to FIG. 5A, the illustrative reference electrode 122, which is preferably transparent, is disposed over a display medium 124, wherein the reference electrode 122 is utilized in completing the electrical circuit necessary for activation of the display medium 124. A clear protective layer (not shown) may be disposed over the transparent reference electrode 122 should it be necessary to prevent physical trauma or damage to the electronic sign or label. The display medium 124 can be formed or constructed of multiple layers of material, but for purposes of illustration and clarity, it is illustrated as a single layer. In one embodiment, the display medium 124 can be flexible and capable of movement in a plurality of dimensions, whereas in an alternative embodiment the display medium 124 is rigid. The display medium 124 is associated with a backplane 126 such that the backplane 126 is capable of creating a display and/or activating a visual indicator on the display medium layer 124. The visual indicator, as described in detail below, can include a graphical or textual representation, such as an icon, a geometric shape, a barcode, 2D symbology or any other like representation. The visual indicator and/or the display can be in black and white, various shades of grey, or can be in color. Combinations of the aforementioned visual indicators may be provided on a single electronic display. Additionally, the display medium 124 may be partitioned into numerous regions. These regions may be a single pixel, a combination of pixels, a font region, or any combination thereof. A region can be of any shape or size, and any number of regions can exists on the electronic display medium 124. Furthermore, each of these regions can display one or more visual indicators. Each of these regions can also or alternatively display two contrasting colors.

The electronic sign or label 100a of FIG. 5A can be attached to an item utilizing numerous means. For example, conventional mechanical fastening system, loop and hook-type arrangements, stitches, adhesives, friction fit, as well as other known fixation techniques may be employed to permanently or temporarily attach the electronic sign or label to an item. The electronic sign or label 100a can also be integrally formed with the item, or can be used as a stand alone electronic sign or label. As used herein, the term sign or label is intended to include a sign or label, card, strip, tag, hanging tag, or general display device that is sufficiently sized and configured for attachment to or association with an item. While the electronic display 18 associated with the electronic sign or label 100a is shown as a plurality of layers in FIG. 5A, those of ordinary skill will appreciate that the sign or label may be made of a single layer. Examples of electronic sign or labels comprising one or more layers suitable for use with the present invention are set forth in U.S. Pat. No. 6,753,830 B2, the contents of which are herein incorporated by reference. Further examples of electronic sign or labels comprising one or more layers suitable for use with the present invention are set forth in U.S. Pat. No. 6,924,781, U.S. Pat. Application No. 6,753,830, U.S. application Ser. No. 10/300514, and U.S. Application No. 60/498983.

Another layer of the electronic sign is the backplane layer 126. Different embodiments of the backplane layer can be designed using addressing schemes based on, for example, pixel, icon or a physical set of related font regions or any combination of one or more of the pixel, icon, or related font regions, as described in detail below. Thin film transistors (TFT) or electrodes of each pixel, icon, or related font regions can be manufactured using any process known in the art. This includes printing, adhering, and/or deposition. The TFT or electrodes can be fabricated from organic, inorganic material. The backplane layer may consist of a single layer of substrate or a plurality of layers.

Dispersed across the backplane 126 of the electronic sign 100a of FIG. 5A is a plurality of conductive traces 128, wherein these conductive traces 128 are oriented to activating a desired display, which may be information relating to an associated item, such as a visual indicator, on the display medium 124. The display medium 124 can be actuated utilizing numerous methods depending upon the intended information to be displayed. The backplane 126 may employ direct drive icon activation, direct drive alpha numeric font region based character activation, row column addressable indicator activation, active matrix indicator activation, passive matrix, or a combination of the above to adequately display selected information on the display medium 124.

An illumination means can be employed separately or in combination depending upon the intended information to be displayed. For example, some characters/symbols may require a direct line to illuminate the display medium, whereas other characters/symbols such as free text may require an active matrix row column, or passive matrix, or a pixel addressable arrangement to adequately display the desired information.

One embodiment of the present invention illustrated in FIG. 5A consists of a layer 124 in an electronic sign consisting of the display medium. The display medium itself may be made of multiple levels of material. The display layer may be bonded to the backplane layer 126 (described below) of the electronic sign 100a. The display medium can be any type of thin material suitable for forming a display.

One embodiment of the electronic sign can use any bi-stable, or multi-stable material in the display layer 124 that is also preferably non-volatile. A suitable material for the electronic ink display layer 124 includes electrophoretic or electrochromic material or electronic ink disposed on a suitable support structure, such as on or between one or more electrodes. Examples of bi-stable non-volatile mediums include but are not limited to encapsulated and un-encapsulated electrophoretic material, Cholesteric materials, polymer dispersed cholesteric liquid crystals (PDChLC), encapsulated cholesteric materials, separated redox and dye reaction materials such as Dow Commotion® display medium, ph sensitive dyes, electrothermochromics displays and thermo-chromic, zenithal bi-stable, nematic, and surface stabilized ferroelectric liquid crystals.

The term “non-volatile” as used herein is intended to denote that the imaging material has indefinite memory without power and will retain an image in the absence of power to the electronic sign or label or sign. The particles in the imaging material maintain a first state unless actively directed to change to a second state. Thus, the imaging surface of the sign or label shows a high-quality image even when power to the sign or label is turned off. The last image presented on the display medium will not instantaneously disappear as soon as power is removed from the display. In such a material, the image will remain visible with sufficient quality and appearance for a period of time after power is removed that exceeds the intended purpose of the application in which the electronic sign is being used. Depending on the exact display materials, electronics and environmental operating condition, the image can remain after withdrawal of power for seconds, minutes, hours, days, months or years. The electronic sign can also be updated/refreshed as required if the period of bi-stability is about to be exceeded since the last time the electronic sign was changed or refreshed.

The term “bi-stable” as used herein is intended to indicate that the particles of the imaging material can alternately occupy two stable states. For example, the particles corresponding to different pixel locations of the display assembly can alternately occupy an ON or an OFF state to form selected indicia. In an illustrative embodiment, the display media is reflective to provide a greater viewing angle to the image displayed by the electronic sign or label 100. In this case, the particles in the imaging material may be oriented in a first state to reflect light (ON) or a second state to absorb light (OFF).

The invention is not limited to a non-volatile display material and may also include a bi-stable volatile display material.

The display layer 124 of the electronic sign 100a can also be a printable, conductive ink having an arrangement of particles or microscopic containers or microcapsules. Each microcapsule has disposed therein an electrophoretic composition of a fluid, such as a dielectric or emulsion fluid or suspension fluid, and a suspension of colored or charged particles or colloidal material that can move depending on an applied charge or current. The diameter of the microcapsules typically ranges from about 30 to about 300 microns. According to one practice, the particles visually contrast with the dielectric fluid. When activated by an electrode, particles within the microcapsules to migrate toward an electrode. This migration can change the color of the sphere, and hence the pixel location, as viewed by an individual. According to one practice, the microcapsules can be filled with electrically charged white particles in a black or colored dye. In another embodiment the suspension fluid can be clear and contain different particles of contrasting colors that can move (typically in opposing directions) depending on an applied electronic charge or electronic current

According to another example, the display layer 124 of FIG. 5A can include rotatable balls that can rotate to expose a different colored surface area, and which can migrate between a forward viewing position and/or a rear non-viewing position, or both. On example of such a material is a gyricon. Gyricon is a material comprised of twisting rotating elements contained in liquid-filled spherical cavities and embedded in an elastomer medium. The rotating elements can be made to exhibit changes in optical properties by the imposition of an external electric field. Upon application of an electric field of a given polarity, one segment of a rotating element rotates toward, and is visible by an observer of the display. Application of an electric field of opposite polarity, causes the element to rotate and expose a second, different segment to the observer. A gyricon display maintains a given configuration until an electric field is actively applied to the display assembly. Gyricon particles typically have a diameter of about 100 microns. Gyricon materials are disclosed in U.S. Pat. No. 6,147,791, U.S. Pat. No. 4,126,854 and U.S. Pat. No. 6,055,091, the contents of which are herein incorporated by reference.

The display layer 124 of the illustrative electronic sign 100a can also include a bi-stable non-volatile cholesteric imaging material. The cholesteric liquid crystal material has positive dielectric anisotropy and can include a chiral material in an amount effective to form focal conic and twisted planar textures. Typically cholesteric imaging material comprises liquid crystal cells ranging in thickness from about 25 microns to about 50 microns. Suitable cholesteric materials are disclosed for example in U.S. Pat. No. 6,154,190, U.S. Pat. No. 6,061,107 and U.S. Pat. No. 5,847,798, the contents of which are incorporated herein by reference.

In addition, the display layer 124 of the electronic sign 100a of the illustrative embodiment of the invention can include zenithal bi-stable display technology to form the bi-stable nonvolatile display assembly comprised of a bi-stable nematic liquid crystal device cell. The bi-stable nematic cell is provided with a surface alignment grating on at least one cell wall and a surface treatment on an opposite cell wall. The material is activated by dc pulses to form an image. Suitable zenithal bi-stable devices are disclosed in U.S. Pat. No. 6,151,096, world patent application number WO09804953A1, world patent application number WO09934251A1, U.S. Pat. No. 6,054,973, world patent application number WO00052671A1, and U.S. Pat. No. 6,151,096, the contents of which are herein incorporated by reference.

Further, the illustrative display layer 124 of FIG. 5A can include a thermo-chromic material. A thermo-chromic material is capable of changing its state alternately between transparent and opaque upon the application of heat. In this manner, a thermo-chromic imaging material develops images through the application of heat at specific pixel locations in order to form an image. The thermo-chromic imaging material retains a particular image until heat is again applied to the material. The display assembly is reusable, rewritable, non-volatile, bi-stable. Visually, black characters are written in a transparent background by applying heat to selected locations or pixels in the display layer. To form color displays other colors, such as red, yellow, and blue are used. Since the rewritable material is transparent, UV fluorescent printings, designs and patterns underneath can be seen through.

The display layer 124 can also include surface stabilized ferrroelectric liquid crystals (SSFLC). Surface stabilized ferroelectric liquid crystals confining ferroelectric liquid crystal material between closely-spaced glass plates to suppress the natural helix configuration of the crystals. The cells switch rapidly between two optically distinct, stable states simply by alternating the sign of an applied electric field.

Magnetic particles suspended in an emulsion comprise an additional display material suitable for use with the electronic sign 100a of the present invention. Application of a magnetic force alters pixels formed with the magnetic particles in order to create, update or change human readable indicia, machine readable indicia or both. Those skilled in the art will recognize that a variety of bi-stable non-volatile imaging materials are available and may be implemented in the present invention.

Examples of electronic ink and methods of fabricating assemblies capable of controlling or effecting the orientation of the ink suitable for use with the present invention are set forth in International Patent Application Publication Number WO 98/41899, International Patent Application Publication Number WO 98/19208, International Patent Application Publication Number WO 98/03896, and International Patent Application Publication Number WO 98/41898, the contents of which are herein incorporated by reference.

The display layer 124 can comprise a combination of any of the aforementioned materials in one or more layers.

The display layer 124 employed by the sign or label 100a of the present invention can also be configured as a single color, such as black, white or clear, and can be fluorescent, iridescent, bioluminescent, incandescent, ultraviolet, infrared, or can include a wavelength specific radiation absorbing or emitting material. There can be multiple layers of display material, each with its own activation grid layer, or multiple display material layers can be serviced by more than one activation grid layer.

Different layers or regions of display material 124 can have different properties or colors. For example a first region or layer may be red and white, while a second region or layer of the sign or label is yellow and white and a third region or layer of the sign or label is black and white. Different regions or layers may be selectively activated in the display. For example, a sales price may be displayed in the first region in red, and a unit price may be displayed in the second region, in yellow. The sign or label is capable of forming color displays by including different display layers for each primary color, in a fashion similar to the operation of a conventional television. Each primary color is selectively activated by addressing particular pixel locations within each display layer. The combination of different primary color pixels enables color indicia to be displayed. Any combination of electronic ink layers and activation grid layers are represented for illustration and discussion purposes as display assembly 124. Moreover, the characteristics of the various layers can be different from each other. For example, one layer can be used to view or display information in the visible light range, while a second layer responds to or emits ultraviolet light. The non-visible layers can alternatively be constructed of non-electronic ink based materials that have the previously listed radiation absorbing or emitting characteristics. The display material employed in connection with the present invention preferably has the characteristic that it does not require power to maintain display of indicia. The support layer suitable for use in connection with the electronic ink and the activation grid layer 126 can be formed of any suitable material compatible with the electronic ink, and include Mylar, Kapton, lignocellulosic material, plastic, non-conducting polymers, and the like.

A reference electrode layer 122 is used in conjunction with the electronic ink disposed upon a display medium 124 and a backplane 126 to form the electronically activatable and addressable electronic display 100a, as shown in FIG. 5A. The electrodes may, in part, control a display of the electronic sign. The electrode and backplane can be disposed on, or cover opposite sides of the display layer 124, or both to provide structure for creating a potential difference across the display medium that causes changes in the appearance of the display material in that particular location, to create part of an overall display.

In addition, a physical set of related font regions can be associated with at least one of the electrodes in the electrode layer 122 or other suitable driver. The related font region members in the physical set can be addressable. Each of the related font region members can be independent or dependently controlled based on the association with at least one of the electrodes in the electrode layer 122. The related font region members can have varying shapes and size and in some instances may overlap. In other instances, the related font regions may not overlap. Related font region members may be on different layers of the backplane 126, as described below.

The electronic sign or label 100a of FIG. 5A can further include an electronics layer 129, which can include an electronics module 127. The electronics module can control the activation of the display medium 124. The electronics module 127 can contain one or more silicon chips, programmable microcontrollers or discrete components used in displaying information, generally as human or machine readable indicia, the display medium 124. The electronics module 127 can selectively activate an addressable pixel location on the backplane 126 to charge the electrodes in the electrode layer 122, and hence activate a particular region/pixel in the display layer 124 to create text and images.

The electronics module 127 of the illustrative embodiment of the invention can further include one or more sensors. These sensors can monitor the external environment in which the electronic sign or label 100a is operating. For example, in one embodiment an external temperature sensor can be employed so that in the event that the electronic display 18 experiences a period below freezing a visual indicator on the display medium can be displayed to a user. Sensors may further monitor humidity, Ph, sunlight, ultraviolet light, chemicals, radioactivity, pathogens, bacteria, viruses or pryons in the environment surrounding the electronic display 18. A sensor may also or alternatively detect the location of the electronic sign 100a. A sensor may also or alternatively detect the location of the electronic sign 100a relative to an insertion location.

Furthermore, the electronics module 127 can transmit and receive information to and from a location or device include other electronic signs or electronic sign inserts or labels using any suitable wireless electromagnetic wave communication link, such as a standard electrical cable, optical fiber, wireless electromagnetic wave network (such as radio frequency or infra red) or any suitable direct or indirect connection or link. The applications and embodiments described below generally employ radio signals or infra red transmitted and received through an applicable antenna or optical transceiver associated with the electronics module 127.

The electronic sign or label 100a of FIG. 5A can also contain conductive traces 128 on the backplane layer 126. The conductive traces can be oriented such that upon assembly of the electronic sign or label 100a electrical continuity between the conductive traces 128 on the backplane layer 126 and the electronic layer 129 can be established by way of embedded electrical contact points or vias 125.

The electronic sign or label 100a of FIG. 5A can preferably retain created indicia on the display medium 124 for a period of time after power to the display medium is removed. The time period for which this visual indicator on the display medium remains present may be controlled by the material properties of the display medium 124, can be controlled by the electronic hardware 127 located on the electronic layer 129, or can be a function of the external environment in which the electronic sign or label 100a is operating or a combination or both. The illustrated electronic sign or label 100a may be of varying size and shape as understood by those skilled in the art. For example, the electronic sign or label 100a may be sized to fit on a shipping container or a pallet. Furthermore, the electronic sign or label 100a can be sized to fit on an envelope, or can be sized to cover a portion of a shelf in a supermarket. Furthermore, the electronic sign card can be sized to fit into existing passive sign card holders.

FIGS. 5B and 5C illustrate two additional embodiments of the electronic sign or label 100. As seen in FIGS. 5B and 5c, the backplane can be combined with the electronics layer using various means. For example, as seen in FIG. 5b, a continuous backplane and electronics layer 136 can be constructed on a single substrate which is then folded to form a compact electronic sign or label 100a′. Such an arrangement eliminates the need for the electrical contact points 125 between the stacked backplane and electronics layer of FIG. 5A.

In an alternate embodiment, as seen in FIG. 5c, the backplane 126 and electronics layer 129 of FIG. 5A can be manufactured on a single substrate 146, thereby resulting in reduced size and/or thickness requirements for the resulting electronic sign or label 100a″.

The layers of the electronic sign 100 of the illustrative embodiment of the invention may be made of thin substrate and the display medium can be thin, as well as in many instances, flexible and/or malleable. In certain embodiments, the resulting electronic sign 100 is itself flexible/malleable. The flexible/malleable characteristic of the electronic sign enables the user to more easily insert embodiments of the electronic sign into an insert area, such as into an existing sign board, an example of which is shown in FIG. 4. In some embodiments, the user may choose to use the electronic sign with a corresponding holder or any other type of holder or may use the electronic sign as a stand alone device independent of any other holders. The electronic sign itself does not necessarily need to be manufactured or assembled with a metal or plastic enclosure, housing, or frame or casing and can therefore be frameless or case-free or housing-free. These substrates can be made of paper, cardboard or thin film plastics, as well as thin PC boards or other suitable materials. The substrates of the various layers 122, 124, 126, etc. can all be the same or each layer can be made of a different substrate. All of the layers can be laminated together or enclosed in 2 layers of laminating material, which laminating material may be flexible/malleable.

The number of layers in the electronic sign 100 of an illustrative embodiment of the invention can vary depending on the user's requirements, the state of manufacturing/assembly, and/or the technology for mounting, printing, or fabricating the necessary electronic components/elements. The types of electronic components used in making the illustrative electronic sign can be discrete or integrated components, ASIC, F.P.G.A., and so on, or combinations thereof. Components and/or electrodes can be made of inorganic and/or organic material. Components can be inserted, “printed”, mechanically applied or created by a deposition process.

Exemplary embodiments of the electronic sign may include a mechanical or electrical sensor/switch (hereinafter “sensor”) located on or in the proximity of the electronic sign 100 to sense whether the electronic sign has been inserted into a sign board, frame, holder, etc. In the illustrative embodiment, the sensor 121 is located on the electronic sign. A processor within the electronics module 127 of the electronic sign can alter the way the electronic sign operates based on whether or not the electronic sign is located on, in or in the vicinity of an insertion area, such as a sign board, frame holder, etc. The sensor 121 may require direct contact with the holder sign board or the sensor can be designed to work without requiring physical contact. This would include but not limited to any type of electromagnetic radiation/waves (light, sound, radio, infrared, and others known in the art).

An electronic sign of an embodiment of the invention may include updateable non-volatile memory in the electronics module 127.

The illustrated electronic sign or label 100 displays information that is either wholly or partly prestored or preloaded, or uploaded, in the sign or label or sign, or created by a processor in the sign or label, or displays information that corresponds or is consistent with or based upon signals received from an external source, such as an activator module, a GPS system and/or another electronic sign. Those of ordinary skill will readily recognize that the information displayed by the electronic sign or label 100 can be any general information corresponding to the item, location, mammal or non-mammal, and which is suitable and appropriate for a particular intended use.

A significant advantage of the electronic sign or label 100 of the present invention is that it is a remotely updateable, remotely alterable, flexible electronic display device that can be formed as part of an item, or it can be used in connection with an item to display selected information. Another advantage of the bi-stable, non-volatile electronic sign or label 100 of the present invention is that it need not employ a power source, or require power to maintain a display of selected indicia on the display layer 124. The sign or label includes indefinite memory without power. Specifically, the indicia formed by the electronic ink does not require power to maintain the selected indicia. Hence, if an activator module interrupts or ceases to transmit power signals to the electronic sign or label 100, or an on board power source is turned off by the processor to conserve power the sign or label can still maintain the displaced indicia in human and/or machine readable form.

The characteristics of the bi-stable non-volatile imaging material contained in the display portion of the electronic sign or label can be modified to give specific predetermined responses to outside physical interrogation. For example, fluorescent ink illuminates when excited with the appropriate radiation from an external source. The characteristics of the electronic ink contained in the display portion of the electronic sign or label can be configured or constructed to give specific predetermined responses to signals received by the electronic sign or label. For example different layers of display with different characteristics optical can be activated to respond with patterns based on a decoded message. The electronic sign or label can also be adapted to alternate between displaying a message in the visible wavelength range and displaying a fluorescent message. Those of ordinary skill will readily recognize that other types of electronic ink can be used including fluorescent, iridescent, bioluminescent, incandescent, ultraviolet, infrared, and wavelength specific radiation absorbing material. A variety of these optical characteristics can be combined to provide additional mechanisms for authentication and security of monetary instruments.

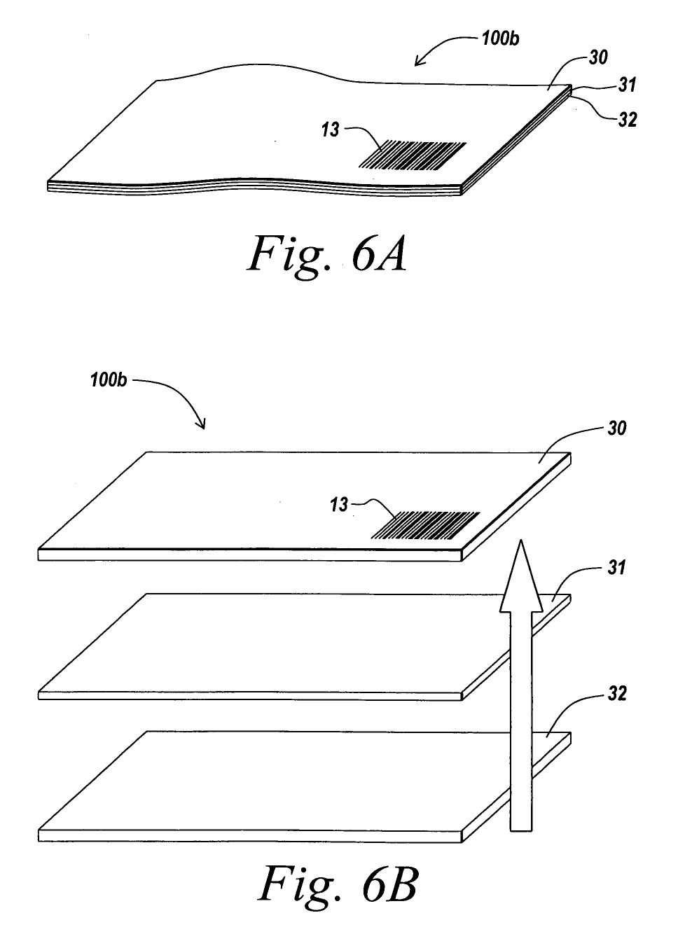

According to one embodiment, shown in FIG. 6A and FIG. 6B, the electronic sign or label 100b can comprise at least three relatively thin, flexible layers that are stacked to form a relatively thin, flexible sign or label 100b. Each layer can comprise multiple sublayers. The top layer forms a display layer 30 for forming and displaying information. According to an illustrative embodiment, the display layer 30 includes a bi-stable, non-volatile display media, such as electronic ink, as described above, capable of forming a display 13. The display layer 30 may further include a top electrode with a protective layer disposed over the layer of display media. The middle layer 31 includes an integrated circuit in the form of a flexible backplane (i.e. a printed circuit board or thin film material or substrate) that is electrically connected to the display layer 30. The bottom layer 32 comprises an RFID (radio frequency identification) layer and display drivers for controlling the information displayed by the display layer. A RFID is a wireless communications device that transmits and receives data via two-way radio. The illustrative RFID layer 32 includes a transceiver and an antenna to facilitate transmission and reception of data related to the information to be displayed by the display layer 30. The RFID layer communicates with a remote controller or device such as a personal computer, PDA, hand held portable device, mobile cart or robot mounted device, ceiling floor shelf or merchandising fixture device, or a node on a network. The remote controller runs an application program that controls and interfaces with the RFID equipment and provides instructions regarding the information to be displayed by display layer 30. The three layers 30, 31, 32 are assembled together, as shown in FIG. 6b to form a thin, flexible sign or label 100b. As shown, one embodiment of the illustrative display layer 30 covers the entire top portion of the sign or label 100b.

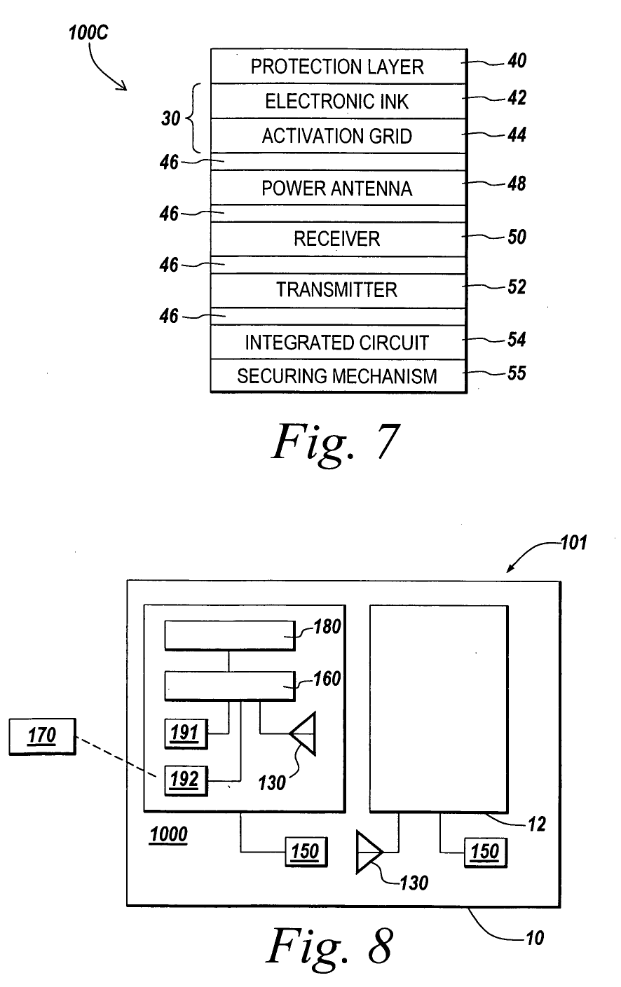

FIG. 7 illustrates an embodiment of the electronic sign or label 100c of the present invention employing a number of stacked layers. With reference to FIG. 7, a protection layer 40 can be disposed over a layer of electronic ink 42 in order to prevent the electronic ink (or display assembly 30) from inadvertent physical trauma and/or environmental damage. The electronic ink layer 42 can be formed or constructed of multiple layers of a display material, such as electronic ink, but for purposes of illustration and clarity it is illustrated as a single layer. The electronic ink is described as a pattern of unique addressable pixel locations or regions. The electronic ink 42 is employed with an electronic activation grid 44, disposed on a support structure, to form the pixel, regional or icon addressable display assembly 30. The illustrated activation grid can be constructed of one or more layers of electronic ink disposed on the activation grid 44 to form a plurality of addressable pixel locations. Each pixel can be addressable by a processor, which can be contained or formed within the integrated circuit layer 54. The processor 24 can control, address, alter or change each pixel location in the activation grid 44 to form indicia.

The pixels or icons or regions of the display layer 124, or 30 of an electronic sign 100 of the illustrative embodiments of the invention can be designed in a variety of geometric shapes and configurations, such as hexagons, squares, dots, triangles or other polygons. One or a plurality of portions of the electronic ink display medium may be manufactured such that physical boundaries of micro cups and/or micro containers are created in such a manner that they form such shapes. Alternatively, the addressable electrodes constituting the backplane can be manufactured such that they form a pattern of such shapes, independent of the physical boundaries of the micro cups and/or micro containers that make up the display medium. Alternatively, the back plane and physical boundaries of physical boundaries of the micro cups and/or micro containers can be matched so that they both form the same pattern of such shapes. Each shape represents a selected addressable portion of the display assembly. The electronic ink covering any specific addressable location may be activated. The coordinated activation of multiple pixels creates a pattern of characters, figures, barcodes, icons, images, photos and other indicia. The geometric shapes forming the pixels can be packed together as part of the manufacturing process for the electronic sign or label, and may be arranged in rows and columns, a honeycomb arrangement or any other suitable arrangement. The activation grid 44 is intended to be employed in connection with the electronic ink layer 42 to form human and/or machine readable indicia. The activation grid 44 can be formed in a variety of manners and can have a variety of shapes and electronic configurations. The activation grid can alternatively be constructed by including a transparent electrode layer located above or on top of the electronic ink layer. The activation grid 44 can be patterned so as provide sufficient power (e.g., current or voltage) at selected pixel addresses to form indicia. Such patterns include quadrilateral shape matrices (e.g., square or rectangular XY matrices), intersecting arcs, and linear and non-linear patterns, as well as other designs. The activation grid 44 can also be formed in a manner that reduces the number of necessary current carrying pathways.

A power antenna 48 may receive power signals to power the sign 100c. A receiver layer 50 receives signals and a transmitter layer 52 transmits signals. A securing mechanism layer 55 may also be used to secure the electronic sign 100c relative to an associated item.

An illustrative embodiment of the present invention provides a method and system for displaying a visual indicator on an electronic display, such as an electronic sign 100, associated with an item to indicate a state, a status and/or a location of the item. The method and system of the illustrative embodiment of the present invention allows a user to visually confirm the state, status and location of an item with which the electronic sign or label is associated. Likewise, the visual indicator provided by the electronic sign or label associated with the item allows a user to visually ascertain that a change has occurred with the item associated with the electronic display. The electronic display of the present invention may indicate the occurrence of a single location change, state change or a status change, or may indicate the occurrence of a number of state changes, location changes, or status changes of an item associated with the electronic display. A single electronic sign or label associated with or affixed to an item can contain a plurality of independent displays, wherein each display is capable of showing unique or interrelated information.

FIG. 8 illustrates a system 101 for electronically displaying information of a tracked item using a transceiver module 120 and an electronic sign or label 1000 according to one embodiment of the invention. The electronic sign or label 1000 can include an interface mechanism 160 for translating information received from the transceiver module 120 into a visual indicator or other suitable indicia that can be displayed on an electronic display 180. The interface module 160 can be further configured to transmit commands, instructions, software programs, and parameters or variables associated with the electronic sign or label, or instructions for use by the electronic sign or label 1000 at a later time, as well as instructions for other functions associated with the operation of the electronic sign or label 1000.

The transceiver module 120 can receive and transmit information concerning the item using a communication protocol. The term “communication protocol” as used herein refers to a format for transmitting data between two devices. The format defines any means by which a signal can be transmitted and can include wired means, wireless means or a combination of both. Wired means can include the use of electrical conductors or fiber optic conductors. Wireless signal transmission can occur using any region of the electromagnetic wave spectrum. For example, the visible light, infrared, microwave, radio frequency, X-ray or gamma ray region of the electromagnetic spectrum can be utilized. An antenna 130 can be coupled to the transceiver module 120 for transmitting and receiving wireless signals. Alternatively, the transceiver module 120 can be an optical device that can receive and transmit optical signals, including infrared. A power supply 150 for providing power to the transceiver module 120 can also be coupled with the transceiver module 120. The power supply 150 can be either internal to the transceiver module 120, or can be eternal to the transceiver module 120. For the purpose of illustration, the power supply 150 has been shown as external to the transceiver module 120, though one skilled in the art will recognize that the invention is not limited to the illustrative embodiment.

The electronic sign or label 1000 can further contain an antenna 130 coupled with the interface module 160. This antenna 130 can be used to send, receive, or send and receive a wireless signal containing information of the item associated with the electronic sign or label 1000. Those of ordinary skill will recognize that any number of suitable antennas can be employed in connection with the electronic sign or label of the present invention. For example, the electronic sign or label 1000 can employ a common antenna perform all necessary functions, a discrete antenna for each function associated with the electronic sign or label, or any subset of antennas for performing one or more functions. The wireless signal received by the antenna associated with the interface module 160 can contain a data signal, a power signal or a combination of both. A power signal can be used to provide power to the electronic sign or label 1000. Absent a power signal, a power supply 150 can be coupled with electronic sign or label 1000. This power supply 150 can be located internal to the electronic sign or label or external to the electronic sign or label. Additionally, the electronic sign or label 1000 can utilize more than one power supply means, wherein a second power supply 150 can be utilized in augmenting a primary power supply. For example, an electronic sign or label 1000 that receives power through a wireless power signal can alternatively utilize an internal external power supply 150 to augment or replace power provided to the sign or label 1000 by an external power signal.

The illustrative electronic sign or label 1000 of FIG. 8 further includes a Radio Frequency Identification (RFID) tag 191. The RFID tag 191 can allow for the remote storage and retrieval of data in connection with the item associated with the sign or label. The electronic sign or label 1000 can also be associated with an Electronic Product Code (EPC) module 192. The EPC module 192 can provide a unique identifier associated with each tracked item in conjunction with the RFID tag 191. The electronic sign 1000 may broadcast the unique identifier to other electronic signs or to a remote device.

Furthermore, data relating to an item can be stored in one or more databases 170 linked to the RFID tag. These databases can reside on the electronic sign or label 1000, or can be linked to the electronic sign or label 1000 through a communication protocol such as an encrypted wireless link. The electronic sign 1000 can among others use communication protocols, messaging formats, etc., such as; Radio frequency, Radio Frequency Identification (RFID), RFID/EPC, 802.11, blue tooth, mesh networking, TCIP, Internet, mesh networking, reflective scatter, backscatter and other protocols known in the art. For the purpose of clarity, the database 170 is shown remotely located from the electronic sign or label 1000.

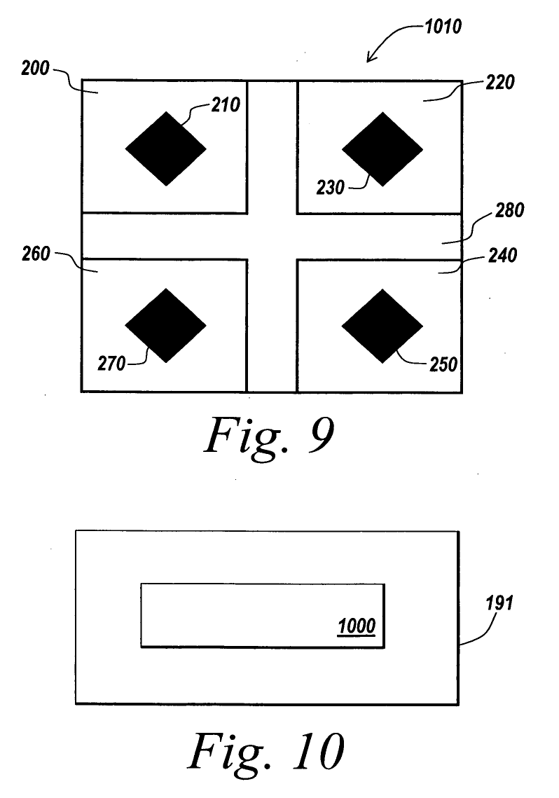

FIG. 9 illustrates an embodiment of an electronic display 1010 associated with an electronic sign or label 1000 according to one embodiment of the invention. The electronic display 1010 can be configured to include a number of regions 200, 220, 240, 260 for displaying one or more visual indicators 210, 230, 250 and 270. The electronic display 1010 can display one or more graphical or textual representations, simultaneously or sequentially, in each of the regions 200, 220, 240 and 260 for use in tracking an item in a supply chain environment. A region is defined as a portion of the electronic sign or label 1000 and can be made of a single pixel, a plurality of pixels, an icon or a combination thereof. A region can be of any size, shape of location can be defined on the electronic display 1010 of the electronic sign or label 1000. In one aspect, the electronic display 1010 associated with an electronic sign or label 1000′ has been divided into four distinct regions 200, 220, 240, 260, each of which is separated by a null region 280. The null region 280 can be made of a material distinct from the material that the electronic display 1010 is manufactured, can be a defined region on the electronic display 1010 on which no graphical indication is displayed, or can be a combination of both. Each region can display one or more visual indicators 210, 230, 250 and 270 in various forms. For example, a visual indicator can be a simple color change, the placement of a symbol such as a circle or triangle, or can include a number of textual or graphical representations. In a supply-chain tracking setting, prior to entering the designated supply chain the electronic sign or label 1000′ has no visual indicators illuminated. After passing through a first step in the supply chain, a first visual indicator 210, on a first display region 200 is displayed. As the tracked item passes through additional stages in the supply chain, additional visual indicators 230, 250, 270 on various regions 220, 240, 260 are displayed corresponding to each state that the tracked item has completed within the supply chain. The non-electronic region 280 located between the various regions 200, 220, 240, 260 allows for the display of non-electronic information such as plain text, graphics, or simply a uniform color. In one embodiment, the non electronic region 280 may have the various locations of the supply chain through which the item will pass printed in plain text. The non-electronic region 280 may be further utilized for any purpose relating to the implementation of the electronic sign or label or may optionally be deleted.

FIG. 10 illustrate the electronic sign or label 1000 when used in conjunction with an RFID tag 191. In FIG. 10, the electronic sign or label 1000 and the RFID tag 191 are physically and electronically combined into a single entity. As illustrated, the electronic sign or label 1000 can occupy a portion of the RFID tag 191 or alternatively the RFID tag 191 can occupy a portion of the electronic sign or label 1000 to form an integrated device. Alternatively, the electronic sign or label and the RFID tag are physically separate, but in communication with each other. The RFID tag 191 and electronic sign or label 1000 can be sized and shaped according to the desired function of the electronic sign or label. For example, the electronic sign or label 1000 can be sized for use with shipping containers, pallets, consumer goods, luggage, employee badges, and access control passes.

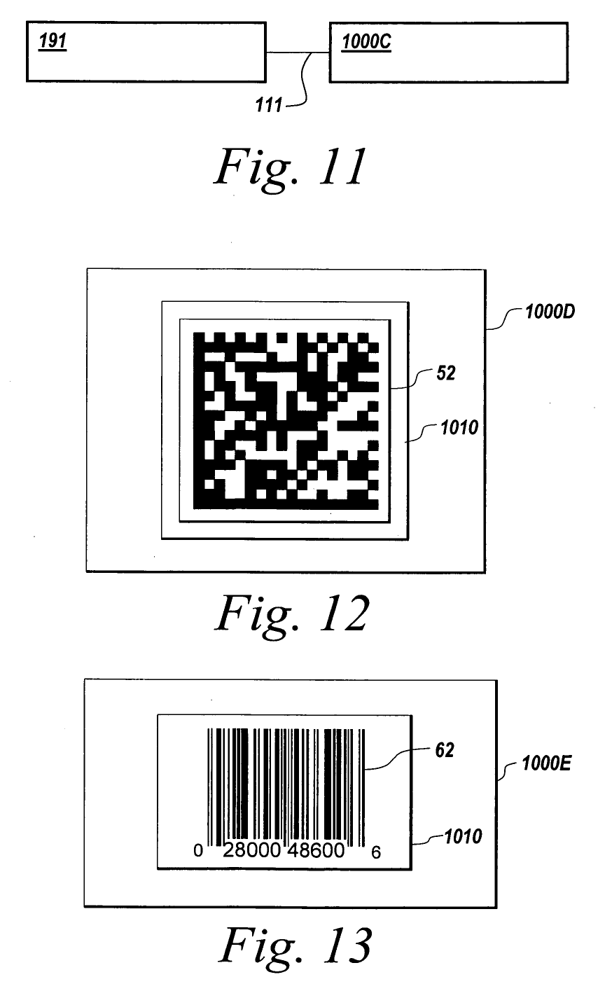

FIG. 11 illustrates the electronic sign or label 1000C when used in conjunction with a RFID tag 191. The electronic sign or label 1004C and the RFID tag 191 are physically and electronically separate from each other. The electronic sign or label 1000C and the RFID tag 191 can communicate via a communication protocol. One example of this communication protocol is a wireless link 111.

FIG. 12 and FIG. 13 show illustrative examples of machine readable data 52, 62, respectively, that can be displayed on an electronic display 1010 associated with an electronic sign or label 1000D or 1000E. As exhibited in FIG. 12, a visual indicator can be presented on an electronic display 1010 associated with an electronic sign or label 1000D in a machine readable format wherein the visual indicator is a matrix array symbology 52. The matrix array can be made up of hexagonal, square, polygonal and/or other geometric shapes, lines, or dots. As further evidenced in FIG. 13, a visual indicator can be presented on an electronic display 1010 associated with an electronic sign or label 1000E in a machine readable format such as a barcode 62.

FIG. 14 illustrates another embodiment of an electronic sign or label 1000F in accordance with the teachings of the present invention. The illustrative electronic sign or label 1000F includes four regions 72, 74, 76, 78 each region is capable of displaying a visual indicator simultaneously or sequentially. A region is a defined portion of the electronic display and can be made of a single pixel or a plurality of proximate pixels. A region can be of any size, shape of location on the electronic display of the electronic sign or label. The electronic display 1010 can have any number of regions of various sizes and shapes. The visual indicator displayed on each of these regions can provide detailed information relating to the tracking of state, status, location or other information relating to an item. For example, the name of the manufacturer, the plant at which the product was produced, as well as the shipping date and company can be displayed in a region 72. After passing from the manufacturer to a distribution center, a new data set including the date received and the date shipped can again be displayed on a different region 74. Information regarding the store/destination is displayed in region 78 and information regarding the warehouse may be displayed in region 76.

For the purpose of illustration, visual indicators displayed in the various regions are provided in plain text, but in practice the electronic sign or label 1000F can provide data on an electronic display in any number of formats including but not limited to machine readable barcodes and symbols, geometric shapes, or varying colors. For example, the visual indicator displayed on the electronic display 1010 associated with the electronic sign or label 1000F may be a machine-readable barcode or a matrix array symbology. Utilizing a barcode or matrix array symbology, detailed information can be presented in an optical or non optical based machine-readable format. The information can relate to past, present or future locations within the supply chain. In the alternative, the visual indicator may include both a human readable display as well as a machine readable display.

The visual indicator on an electronic display 1010 of an illustrative embodiment of the present invention can be used to display at least one of a past location, a present location or a future location of the item to be tracked. A future location of an item can be a new location or can be a return to a previous location. For example, an item can move from a shelf in a warehouse to an inventory control point within the same warehouse. This can be viewed as a move from a past to a present location. The item can then move from the present location, the inventory control point, to either a truck for delivery or can be return to the shelf in the warehouse. The move from the inventory control point to either the awaiting truck, or the shelf in the warehouse is a move from a present location to a future location. The present invention also provides a visual indication of current location of the electronic sign or label attached to an item without the need for any knowledge of past or future locations relating to the item.

In one embodiment, information indicated on the various regions of the electronic display 1010 associated with the electronic sign or label 1000F may remain for a fixed period of time upon the removal of power from the electronic display 1010. This time period may be a function of the material properties of the electronic display 1010, a function of the operating environment of the electronic display, or may be controlled by the interface module of the electronic sign or label. Operating environment factors include, but are not limited to, temperature, humidity, pH, sun light, ultraviolet light, as well as the presence of various chemical compounds, radioactivity, pathogens, bacteria, viruses or pryons. The operating conditions may be sensed by a sensor located on or in the vicinity of the electronic sign.

FIG. 15 illustrates another use of an electronic sign or label 1000G in accordance with the teachings of the present invention when used as an indicator of a state of the electronic sign or label 1000G. In one embodiment, the electronic sign or label 1000G can be part of a larger sign or label 80 wherein two or more display mediums are combined. A first medium can be a traditional print advertisement 82, and the second medium can be an electronic sign or label 1000G as taught in the present invention. In the embodiment shown, the electronic sign or label 1000G is used to serve as an indicator of state of an attached RFID tag (not shown). Those skilled in the art will appreciate that the RFID tag is integrated into the electronic sign or label 1000G, or in the alternative is not integrated in the electronic sign or label 1000G but is in communication with the electronic sign or label 1000G. The presence of a visual indicator on the electronic display 1000G can indicate that the RFID tag (not shown) associated with the electronic sign or label 1000G is activated. An extinguished visual indicator on the electronic sign or label 1000G can indicate that the RFID tag (not shown) is inactive. In light of the inherent privacy concerns associated with RFID tags that unintentionally remain active after a user purchases an item and leaves a store, providing a visual indication that the RFID tag associated with an item is no longer capable of transmitting serves to alleviate any privacy concerns a consumer may have. The use of the present invention to verify the status of a RFID tag 191 is presented solely as an example of the potential uses.

The visual indicator may additionally take numerous forms, and is not limited to the circular arrangement presented as an example. In one embodiment, a varying color change may be utilized to indicate a state change. In an alternate embodiment, numerous visual indicators may be associated with the electronic sign or label 1000G, wherein human readable or machine readable information is presented on each indicator. Furthermore, the electronic sign or label 1000G of the present invention may be sized such that it alone is the indicator of RFID tag state, or can be a portion of sign or label 80 which combines a first media 82 and second media 1000G. The first media 82 can be a non-alterable print advertisement, and the second media can be an alterable electronic sign or label in accordance with the present invention 1000G.

FIG. 16 illustrates an electronic sign or label 1000H of the present invention when used as a read indicator. A read indicator in accordance with the present embodiment will change from an initial state to a new state upon a successful read. These state changes may be indicated on an electronic display 1010 by the appearance of an icon or color change, or may be indicated by the appearance of a pre-determined message. Additionally, the electronic sign or label 1000H may incorporators a plurality of regions wherein a plurality of read indicators is employed on an electronic display, such that the read status of an item at numerous locations can be visually depicted. For the purpose of clarity, a single region is shown in the present embodiment.

In FIG. 16, a read indicator is shown in two alternate states, namely an unread state 92 and a read state 94. In both states, an electronic sign or label 1000H display can provide a visual indication following a change in state of item to which the read indicator is attached. As illustrated in the unread 92 state, no graphical indication is displayed on the electronic sign or label 1000H prior to a successful read of the tag associated with the electronic sign or label 1000H. Following a successful read of the tag associated with the electronic sign or label, the electronic sign or label 1000H′ can provide a visual indicator 161 to a user. This visual indicator proves useful in inventory management and supply chain tracking, as absent a read indicator associated with an electronic display it is difficult to determine if an item with an electronic tag has been successfully scanned and entered into inventory.

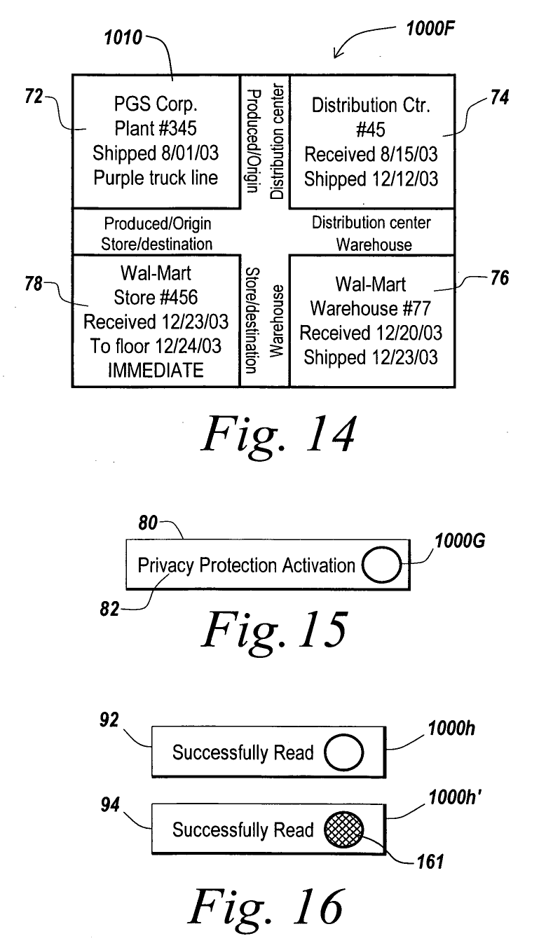

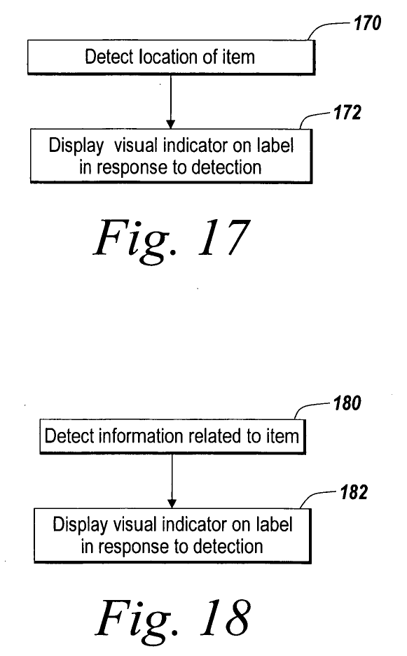

FIG. 17 is a flow diagram which illustrates a method of marking an item in accordance with an embodiment of the present invention. In step 170, the item is detected at a location, or a change in a location of the item is detected. In step 172, a visual indicator is displayed on the electronic sign or label associated with an item in response to detection of the item at the location. The detection can be calculated based upon information derived from one or more locations. Upon detecting a location of an item a visual indicator is displayed on the electronic display associated with the electronic sign or label. This visual indicator can be a graphical object, a machine-readable barcode, a human readable text string, or any combination thereof. Data displayed by the electronic sign or label can be in black and white, contrasting colors, a full color display or a combination thereof. Additionally, the visual indicator can occupy the entire electronic display, or can be displayed in one or more regions of the electronic display. Furthermore, the electronic display can continue to display data for a period of time after power to the display medium is removed. The time period for which the visual indicator continues to display data may be controlled from within the electronic sign or label, may be a function of the material properties used to construct the electronic display, or may be a function of the environment in which the sign or label is operating.

FIG. 18 is a flow diagram which illustrates a method for tracking an item in accordance with another embodiment of the present invention. In accordance with step 180, information related to the item, such as a change in the state of the item, is detected. In step 182, a visual indicator is displayed on the electronic sign or label in response to the detected information. The information can be based upon monitored state data, or can be derived from data supplied to the electronic sign or label. For example, state data may include, but is not limited to a read or unread status of the tag associated with an item or activated or deactivated status of an electronic sign or label associated with the item to be tracked. This visual indicator can occupy the entire electronic display, or can be located on one or more regions of the electronic display. The visual indicator can be in black and white, grayscale, color, or some combination thereof. Furthermore, the visual indicator can be in a machine-readable format, a human readable format, or some combination of the two. The electronic display can continue to display state data for a fixed period of time after power tone or more portions of the electronic sign or label is removed. The time period for which the electronic display continues to display data may be controlled from within the electronic sign or label, may be a functional of the material properties used to construct the electronic display, may be a function of the operating environment of the sign or label, or may be some combination thereof.

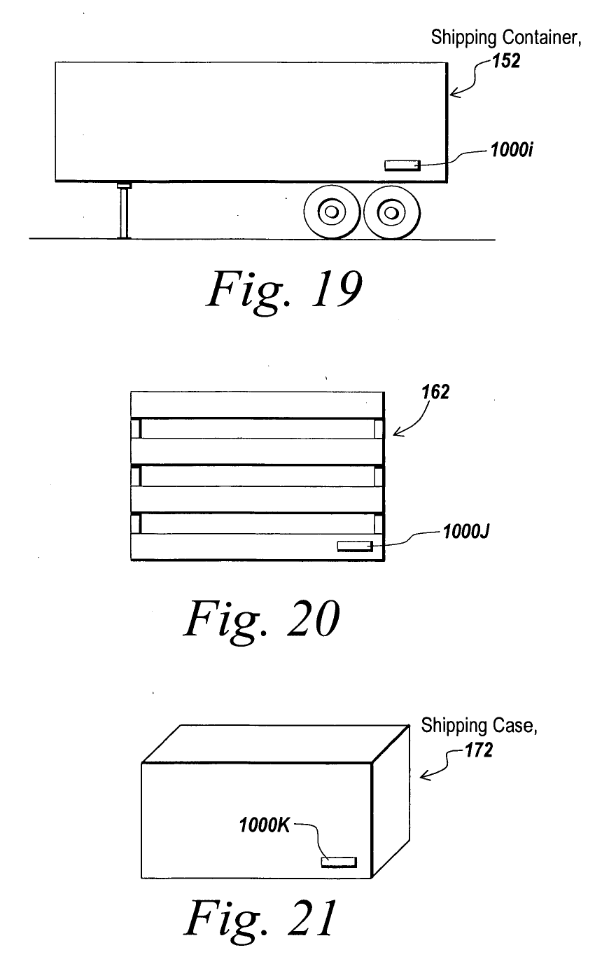

FIG. 19 illustrates an electronic sign or label 1000I of an embodiment of the present invention when used in conjunction with a shipping container 152. The shipping container 152 can be located at a loading dock or warehouse and can be mobile in nature. An electronic sign or label 1000I can be attached to the shipping container 152 using various permanent or temporary means as understood by those skilled in the art. The electronic sign or label 1000I can further display a visual indicator signifying the state, status, location or some combination thereof of the shipping container 152.

FIG. 20 illustrates an electronic sign or label 1000J of an embodiment of the present invention when used in conjunction with a pallet 162. The pallet 162 can be located at a loading dock or warehouse and can be mobile in nature. An electronic sign or label 1000J can be attached to the shipping container 162 using various permanent or temporary means as understood by those skilled in the art. The electronic sign or label 1000J can further display a visual indicator relating to the state, status, location or some combination thereof of the pallet 162.

FIG. 21 illustrates an electronic sign or label 1000K of an embodiment of the present invention when used in conjunction with a shipping case 172. The shipping case 172 can be located at a loading dock or warehouse and can be mobile in nature. An electronic sign or label 1000K can be attached to the shipping case 172 using various permanent or temporary means as understood by those skilled in the art. The electronic sign or label 1000K can further display a visual indicator signifying the state, status, location or some combination thereof of the shipping case 172.

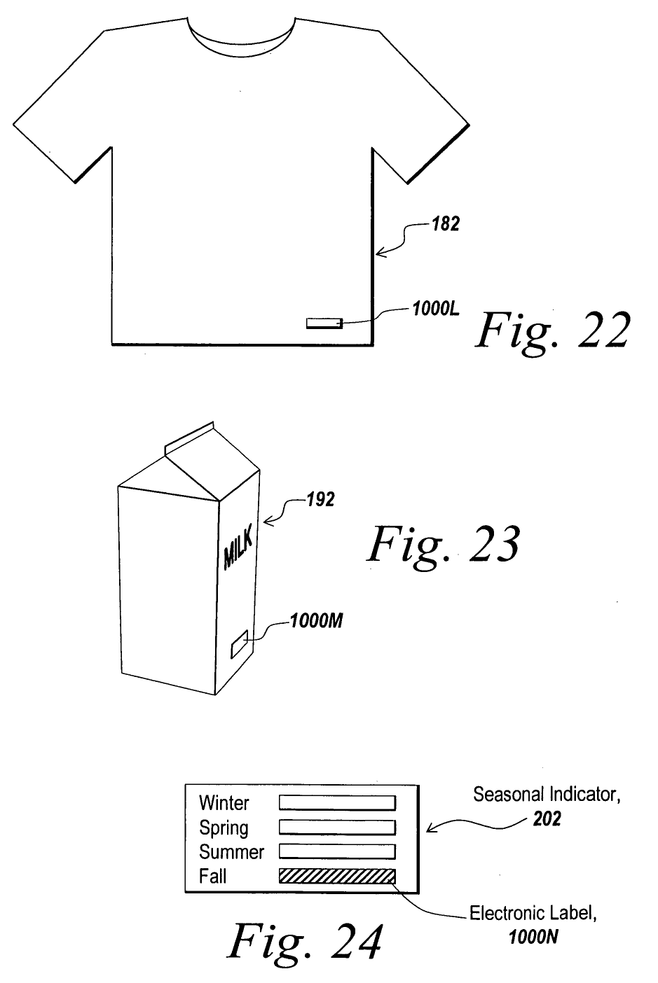

FIG. 22 illustrates an electronic sign or label 1000L of an embodiment of the present invention when used in conjunction with a consumer good 182. The electronic sign or label 1000L associated with the consumer good can display information such as price, manufacturing date, or washing instructions. The electronic display 1000L associated with the consumer good 182 can further display an owner's name.

FIG. 23 illustrates an electronic sign or label 1000M of an embodiment of the present invention when used in conjunction with a perishable product 192. The electronic sign or label 1000M associated with the perishable product can display an expiration date, or can utilize a sensor associated with the electronic sign or label 1000M to display a graphical indicator is the perishable good has experienced a period without proper refrigeration.

FIG. 24 illustrates an electronic sign or label 1000N of an embodiment of the present invention when used as a seasonal indicator 202. The seasonal indicator can incorporate an electronic sign or label 1000N wherein the electronic sign or label can display a graphical indicator indicating the current season.

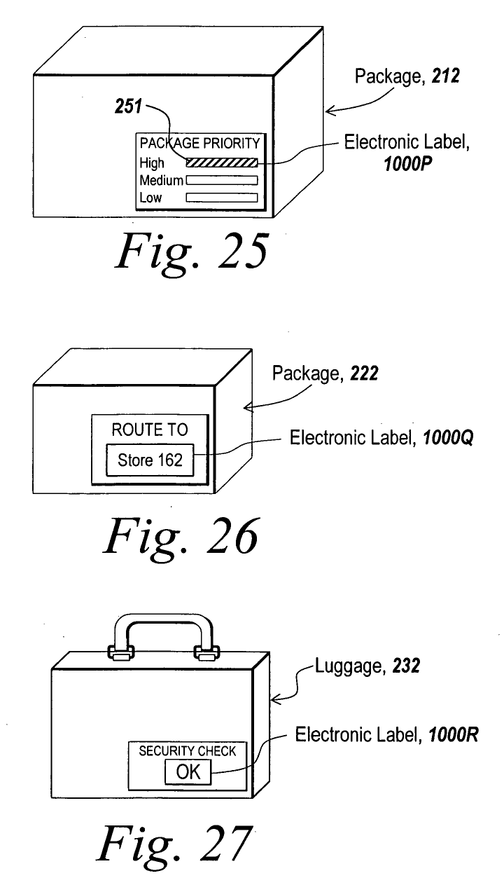

FIG. 25 illustrates an electronic sign or label 1000P of an embodiment of the present invention when used in conjunction with a package 222 to indicate package priority. For example, the illustrative label 1000P displays an indicator 251 next to the word “high” in the label 1000P to indicate that the package has high priority.

FIG. 26 illustrates an electronic sign or label 1000Q of an embodiment of the present invention when used in conjunction with a package 222 to indicate package routing information. Routing information displayed on the electronic sign or label may be in a human readable form, or may be an optical or non-optical machine readable form such as a barcode or matrix array.

FIG. 27 illustrates an electronic sign or label 1000R of an embodiment of the present invention when used in conjunction with luggage 232 as a security check indicator. The electronic sign or label 1000R can display a variety of visual indicators to graphically depict if a piece of luggage 232 has been properly checked through security.

FIG. 28 illustrates an electronic sign or label 1000S of an embodiment of the present invention when used in conjunction with an employee badge 242. The electronic sign or label 1000S can display one or more graphical indicators relating to the security scan status of an employee badge 242.

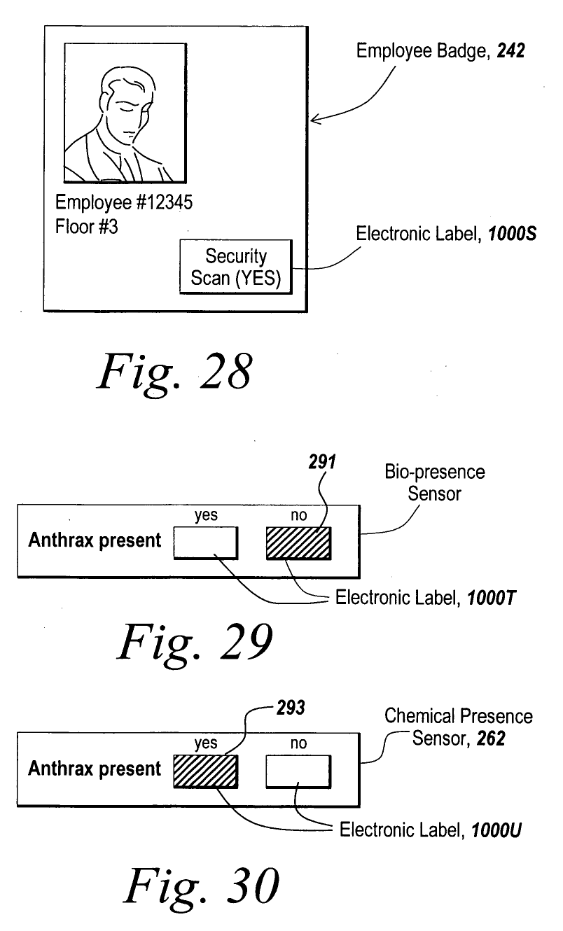

FIG. 29 illustrates an electronic sign or label 1000T of an illustrative embodiment of the present invention when used as a bio-presence sensor 252. The electronic sign or label 1000T can display one or more graphical indicators relating to the presence of a biological entity. The illustrative label 1000T displays an indicator 291 indicating that anthrax is not present.

FIG. 30 illustrates an electronic sign or label 1000U of an illustrative embodiment of the present invention when used as a chemical presence sensor 262. The electronic sign or label 1000U can display one or more graphical indicators relating to the presence of a chemical composition. The illustrative electronic label 1000U indicates that anthrax is present using indicator 263.

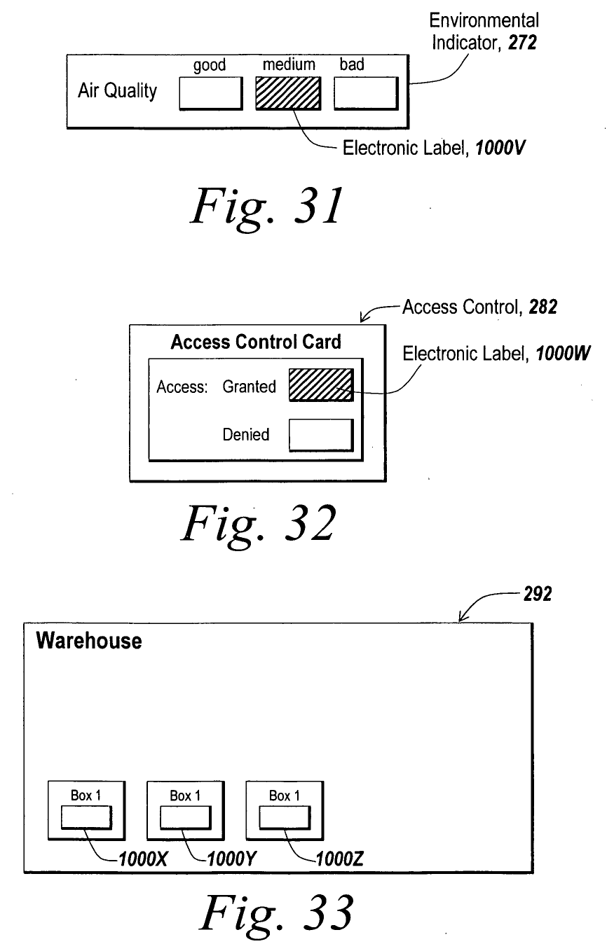

FIG. 31 illustrates an electronic sign or label 1000V of an illustrative embodiment of the present invention when used as an environmental indicator 272. The electronic sign or label 1000V can display one or more graphical indicators relating to the environmental factors such as the Ultraviolet index, pollen count, or air quality. The illustrative label 1000V provides an indicator 273 under the word “medium” to indicate medium air quality. If the air quality were different, the label 1000V would provide a different indicator in another region.

FIG. 32 illustrates an electronic sign or label 1000W of an illustrative embodiment of the present invention when used as an access control indicator in an access control setting 282. The electronic sign or label 1000W can display the state or status of the access control card, such as whether access is granted or denied.

FIG. 33 illustrates electronic sign or labels 1000X, 1000Y, 1000Z of a present invention when used as part of a pick to light warehouse automation system. The electronic sign or labels 1000X, 1000Y, 1000Z of the present invention can be used in a warehouse 292, wherein the electronic sign or labels 1000X, 1000Y, 1000Z are associated with a plurality of items within the warehouse 292.

According to another embodiment of the invention, a backplane layer in an electronic sign can be pixel, font region, and/or icon addressable or have a combination of one or more of the pixel, font region, or icon addressability. The backplane can itself be made of several layers each containing unique patterns of information or transistors or electrodes. Each addressable portion of the backplane of the electronic sign may have a different pre-canned message outlining or filled represented by a unique corresponding electrode in the electronic sign. Depending on which message the processor of the electronic sign wants to activate (show) the appropriate corresponding electrode (layer) is addressed. The other unaddressed messages do not appear.

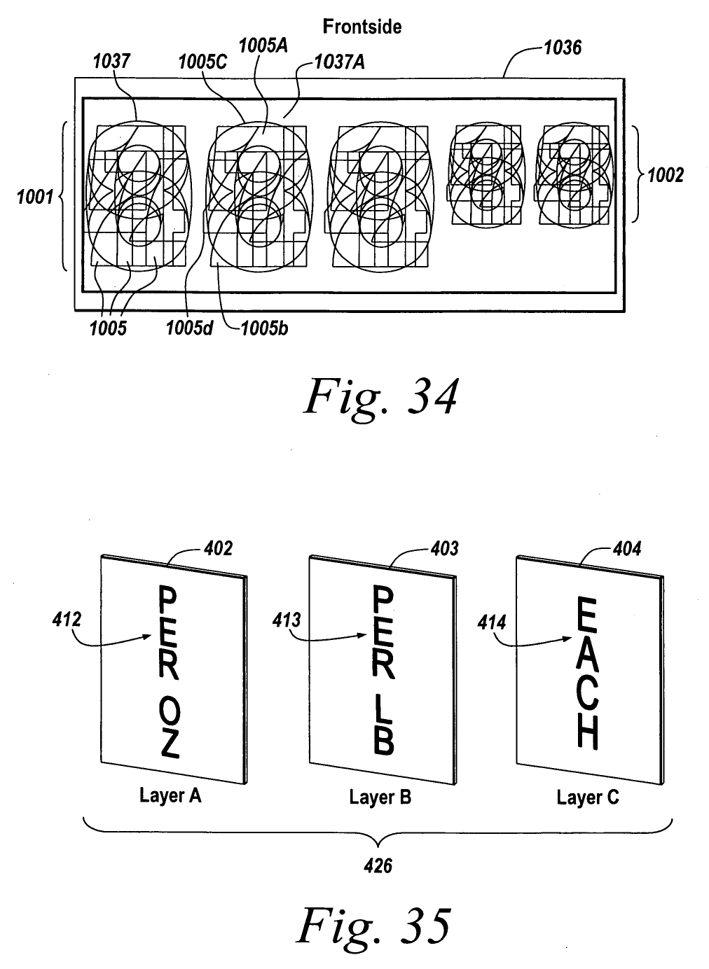

For example, FIG. 34 depicts an illustrative backplane 1036 an exemplary configuration of a physical set 1037 of related font regions 1005 for an electronic sign that enables creating numbers glyphs having a selected typeface at a selected size and/or a selected style. The illustrative backplane 1036 comprises multiple layers, each layer having a unique, addressable pattern forming different fonts. The illustrative backplane 1036 creates unique patterns of addressable elements. Using these patterns of addressable elements, the corresponding display layer can create numbers on special characters that match well known and often used fonts, such as in one embodiment Helvetica Bold. For example, the physical set 1037 of related font regions 1005 in FIG. 34 can depict glyph using Helvetica Bold font. The size of each glyph displayed may vary with in each physical set of related font regions or may be fixed for each physical set of related font regions. As an example of a size associated with a glyph, one glyph displayed on electronic 1000 can have a maximum size 1001, while another glyph display on the electronic sign 1000 can have a minimum size 1002.

Each font region member of the physical set can be addressable via at least one corresponding electrode in an electrode layer 122 to activate a bi-stable display medium 124, such as electronic ink, disposed between the common/reference electrode and the addressable portions, such as electrodes, that make up the backplane 1036. The related font regions can vary in size and shape and may or may not overlap. In the exemplary physical set 1037 of related font regions 1005, each physical set 1037 may include approximately 124 related font regions to create glyphs having the Helvetica font. The number of related font regions can be determined such that a minimum number of related font regions are used to emulate a selected font having a selected type, size and style. In some instances, more related font regions may be used or required. In other instances, fewer related font regions may be used or required. The glyph can have a selected typeface at a selected size and a selected style. For example, the glyph can have a typeface of Helvetica, Courier New, Arial, Time New Roman, etc., and can have a style, such as bold, italicized, underlined, etc. In addition, embodiments can include a various numbers of related font regions to create full Alphanumeric and character sets at each location of a physical set. Some embodiments may provide different physical sets of related font regions to create different font sizes (point size) as well as different typefaces. There can be combination of different sets on the same electronic sign 1000.

In another example, shown in FIG. 35, a backplane 426 for an electronic sign can be made of several layers stacked together, each backplane layer containing a unique pattern of related font regions of addressable elements, such as transistors or electrodes, representing information. FIG. 35 shows multiple layers 402-404, where each layer provides a different pre-defined message 412-414, respectively, outlining or filled represented by a unique electrode. Depending on which message the processor wants to activate (show) the appropriate electrode in the corresponding electrode layer is addressed. The other unaddressed messages will not appear. This multi-layered approach can also be used in another embodiment to accommodate a configuration where various a number of related font regions of a physical set are located on the same layer or spread out among a plurality of layers. Electrical continuity can be, among other method known in the art, accomplished between layers, including the common/reference layer by vias.

The addressable portions/elements of the illustrative backplane 126, 1036 or 426 may be transistors (TFT, printed organic, inorganic transistor) diodes, or simply electrodes or any other components used in the industry or known to one familiar with the art. The process by which a backplane is manufactured can be any of those known to one familiar with the art.

A common or reference electrode layer may also be included in the electronic sign 100, as described above. This layer can be constructed ITO material or any other transparent conducting material.

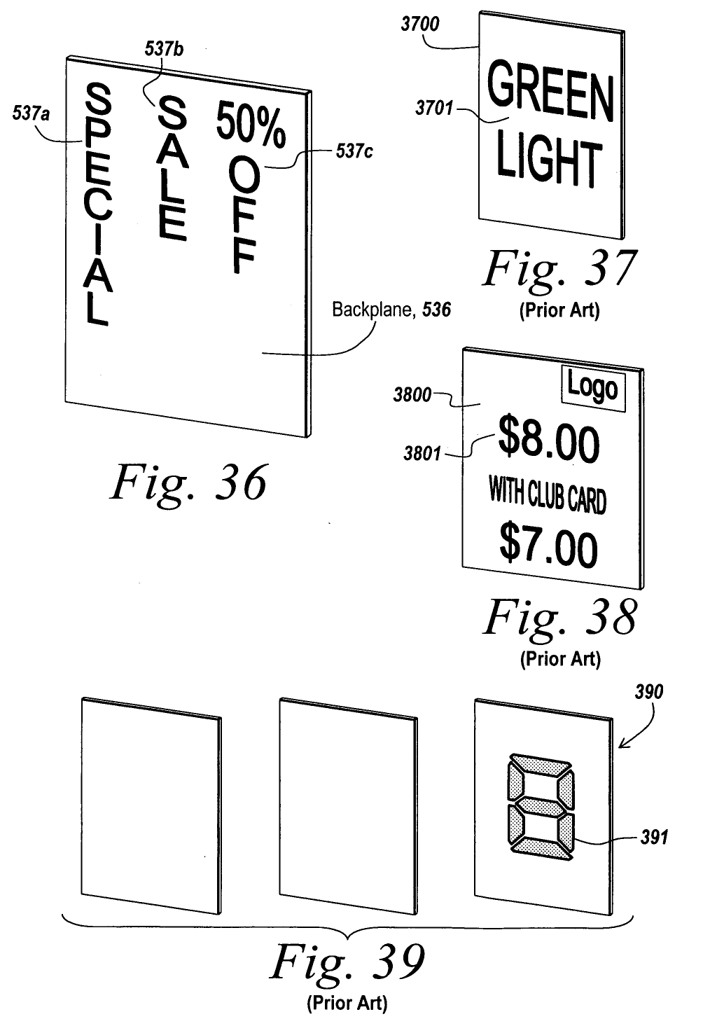

FIG. 36 shows a single layered backplane 536 in which multiple messages 537a, 537b, 537c are available for addressing and thereby displaying, according to still another embodiment of the invention. In this embodiment, as opposed to embodiments that provide multi-layers in a backplane, as described above, an unselected message may take up a noticeable amount of area on an electronic sign 1000.

Pixel addressability in an electronic sign or label 1000, as represented by prior art FIG. 37 and FIG. 38, allows the user address individual pixels. For example, the sign 3700 in FIG. 37 displays the message 3701 “green light”. The electronic sign 3800 in FIG. 38 provides information 3801 regarding the price of a product. The electronic sign or label depicted in FIG. 37 and FIG. 38 are not considered to include a physical set of related font regions to form alphanumeric characters along with special characters. The pixel addressability of the electronic sign or label 1000 as represented by prior art FIG. 37 and FIG. 38 tend to be pixilated and results in limited resolution and readability.

Creating messages on individual electronic signs using a physical set of related font regions to form alphanumeric characters along with special characters and predefined messages may be limited to working within the space in which there are addressable parameters. Creating messages on individual electronic signs using a physical set of related font regions to form alphanumeric characters along with special characters in accordance with the teachings of the present invention result in signs that are substantially free of pixilation and are highly readable as compared to the prior art pixel addressable displays.

FIG. 39 shows a prior art example of the most limited backplane: a backplane 390 capable of only creating individual digits 391 using one of seven segments. There are very crude and block like looking digits.

Referring again to FIG. 34, an embodiment whereby unique patterns of individually addressable related font regions 1005 in an electronic sign is provided. In one embodiment, the physical set 1037 of related font regions can have a range from about 124 to about 164 related font regions 1005. These related font regions can create glyphs, such as numbers, characters, special characters or other symbols that replicate well known and often used fonts that have various typefaces and that also can have various sizes and styles. For example, an embodiment can display glyphs using Helvetica Bold fonts on the electronic sign 1000 that are not limited in size. For example, in a first physical set 1037a, a first font region 1005a in a layer has the pattern of the number “1” in a particular font. A second font region 1005b has the pattern of the number “2” in a particular font. A third font region 1005c has the pattern of the number “8” in a particular font. A fourth font region 1005d has the pattern of the number “4” in a particular font, and so on. Each is selectively addressable to create a display.

In creating the large number of physically related font regions required to support known fonts such as Helvetica, Helvetica Bold, Times Roman, etc., the backplane 426 may be constructed of multiple layers.

Embodiments of electronic signs discussed herein can be manufactured in a variety of dimensions. Some dimensions will specifically be designed to match dimensions of existing sign board inserts to replace conventional sign cards, some of which are depicted in FIGS. 1-3. The dimension of other embodiments can be tailored/customized to specific customer requirements. As such, the height, width, length and depth (i.e. thickness) of electronic signs in accordance with exemplary embodiments can vary.

The thickness of an electronic sign of an illustrative embodiment of the invention can vary, depending on the application. Depending on the application the thickness of an electronic sign can be larger or smaller. For example, when the electronic sign is inserted into a channel or groove for holding the electronic sign, the thickness can be specified so that the electronic sign fits the channel or groove. In some embodiments, the thickness of electronic sign can be such that the electronic sign can replace the paper, card board, or plastic inserts that retailers currently place into their existing frames, holder, plastic stands, fixtures, etc. Thus, in addition to the electronic functionality of the electronic sign to display glyph of varying typeface, size, and style, the form factors of the electronic signs can change to fit a multitude of applications making the electronic signs of the present invention desirable for many applications.

Certain embodiments of the invention provide the ability for an electronic sign board insert to physically replace existing passive sign board inserts by; the manner in which the total number of layers required to construct the electronic sign board insert is minimized, the types of material used for each the layers (many embodiments utilize thin flexible, malleable substrates), the type of display material (many embodiments utilize a thin, malleable display material), various layers being stacked/assembled on top of each other, the selection and placement on the substrates of low profile (thin) components, and the manner in which the all the layers are joined together without the need for a rigid frame, case or housing.

Different embodiments of pixels or related font regions in a physical set of an electronic sign of an illustrative embodiment of the invention can be capable of supporting a single digit or single message. Other embodiments can have different dimensions capable of supporting multiple digits, characters and/or messages in a single electronic sign. The electronic sign can be configured to support multiple lines or columns of information. Information on pixel, or all points addressable electronic sign can appear anywhere and in any order on the electronic sign. The electronic sign can come in various contrasting colors, such as black on white, white on black, or in full color.

Embodiments involving pixel addressable backplanes will be created having specific measurements. The number of digits or images, pictures, icons, etc., that can be presented in a given area on these type signs will vary depending on d.p.i., font and point size (e.g., 8 pts versus 12 pts), etc. used to create the total message.

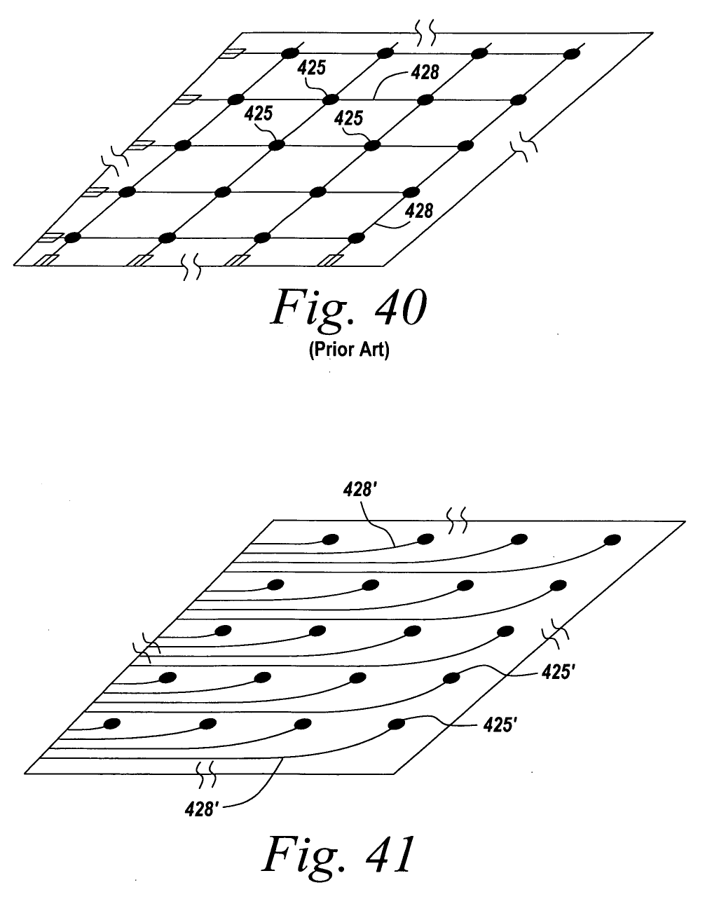

The addressable points of the backplane of an electronic sign of an illustrative embodiment of the invention may have different embodiments. For example, the pixel (all points) addressable backplane of the invention or any other display can be in traditional row/column addressing, as represented by FIG. 40. In this embodiment, the conductive traces 428 are in a row/column grid form, with the electrode points 425 at the intersection of the traces 428.

Another embodiment of a pixel, all point addressability, as shown in FIG. 41 is where each point 425′ has its only single point electrode. In this embodiment, each trace 428′ has a dedicated electrode point 425′ at an end.

The electrodes associated with point electrodes or pixels can be manufactured in any geometric shape and of any size.

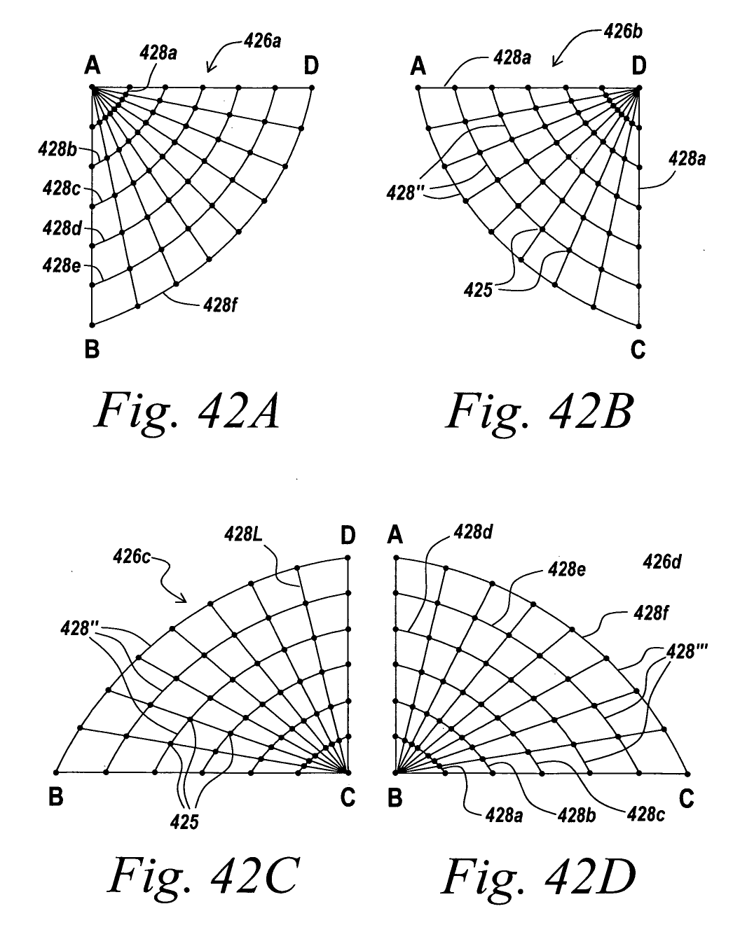

FIGS. 42A-42D show a radius and arc pixel, all points addressing scheme which can be used for electronic sign application or any display application. The entire backplane of a radius and arc pixel configuration for an electronic sign employing this scheme can be composed of four layers, where each layer is represented by one of the sub-figures of FIG. 42. When the backplane 136 is assembled by stacking each layer 426a-426d, the points with the same letter (A, B, C, D) in FIGS. 42A-42D overlay each other. In this way, the density of arc and radius points within a given area that are addressable (given that space is needed for the tracer) is increased. In this embodiment, the traces 428″ are in the shape of parallel, growing arcs 428a-428f with common center A, B, C or D, with intersecting line traces 428g-o in a fan arrangement extending from central point A, B, C or D. The electrode points 425″ are located at the intersection of the arc traces and the line traces.

The electronic signs of the illustrative embodiments of the invention can receive their power directly from an on board power sources (battery, capacitor, and other power sources known in the art), plugged directly into alternated current (AC), or from off board sources (electromagnetic waves/radiation, radio waves, inductively coupled, capacitance coupled, solar, infrared, ambient light, near field, far field) or any combination of the previously listed sources.

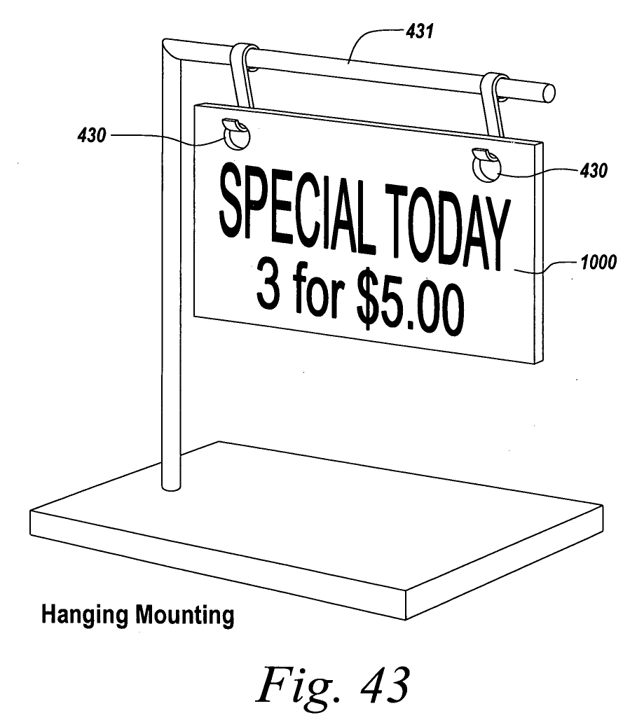

Another embodiment of an electronic sign of an illustrative embodiment of the invention can have holes 430 in the electronic sign 1000 to facilitate hanging the electronic sign from/by hook(s) 431 such as shown in FIG. 43. In addition, the electronic sign can be mounted on the wall.

In another embodiment, electronic signs 1000 can be inserted into the molding on store shelves or warehouse shelves. The electronic sign 1000 can be as long as the length of a section of shelving or railing.

In one embodiment, the electronic components of an electronic sign can be located on either their own third layer/substrate or attached or manufactured on the back of the second (backplane) layer. In either case, the electronic components can be located so that they themselves fit into the channels or grooves of an insertion area, such as a sign board, as they slide into the channel which physically supports them. For example, FIG. 44 shows the back of an exemplary electronic sign 1000 prior to sliding the electronic sign into the channel of a sign board 440. FIG. 44 depicts locations corresponding to various electronic components that can be included on an exemplary electronic sign 1000i. For example, the illustrative electronic sign 1000i includes a substrate 1044, various components 1045, which may be a power source, such as a battery, which may be rechargeable, or capacitor and various electronic components. In other embodiments, the electronic components can be placed anywhere, either on their own third layer/substrate or on the back of the second layer/substrate referred to as the backplane layer. Other embodiments may involve combinations of electronic components being located in the channel area or anywhere else. An antenna 1046 may be also formed on the substrate 1044.

Some embodiments may include one or more switch/sensor (location varies by embodiment) which lets the electronic sign processor know that the electronic sign is in the process of being inserted or is fully residing in an insertion area, such as a channel, or a tab, or a chain, etc. The switch/sensor may require direct contact with the holder sign board or frame or support. The switch/sensor can also be of a design that works/functions without requiring physical contact. This would include but not limited to any type of electromagnetic radiation/waves (light, acoustic, radio, radar, infrared) mechanism. For example, still referring again to FIG. 44, a sensor 1600 can be located on the back, or in another suitable location, of the electronic sign 1000 such that when the electronic sign in FIG. 1000 is inserted into an insertion region, such as a channel, the sensor 1600 senses that the electronic sign 1000 is inserted. In each different embodiment the exact locators or type of switch/sensor may be different but the purpose is always the same.

In certain embodiments, the sensor switch may be omitted or permanently or temporarily disabled or inactivated by manually setting it or another switch to the appropriate position or by sending it an electronic command. Some positions for the switch/sensor may include: inserted, not inserted, activate always, off, manually activated.

If the sensor 1600 recognizes that the electronic sign 100 is not interested in an insertion location or not properly inserted in a corresponding insertion area, the sensor 1600 may prevent the electronic sign from operating, updating, refreshing or changing to conserve power while the electronic sign is not being used in an application.

A main system can communicate bi-directionally or in any other manner with the electronic sign 1000 using a wireless communication infrastructure (radio frequency light, acoustic). Each electronic sign 1000 may have its own unique identifier/serial number, which it can transmit back upon request or whenever the electronic sign decides is the appropriate time. The electronic sign 1000 can also transmit the unique identifier/serial to other linked electronic signs. The electronic sign 1000 can among others use communication protocols, messaging formats, etc., such as; Radio frequency, Radio Frequency Identification (RFID), RFID/EPC, 802.11, blue tooth, mesh networking, TCIP, Internet, mesh networking, reflective scatter, backscatter and other protocols known in the art.

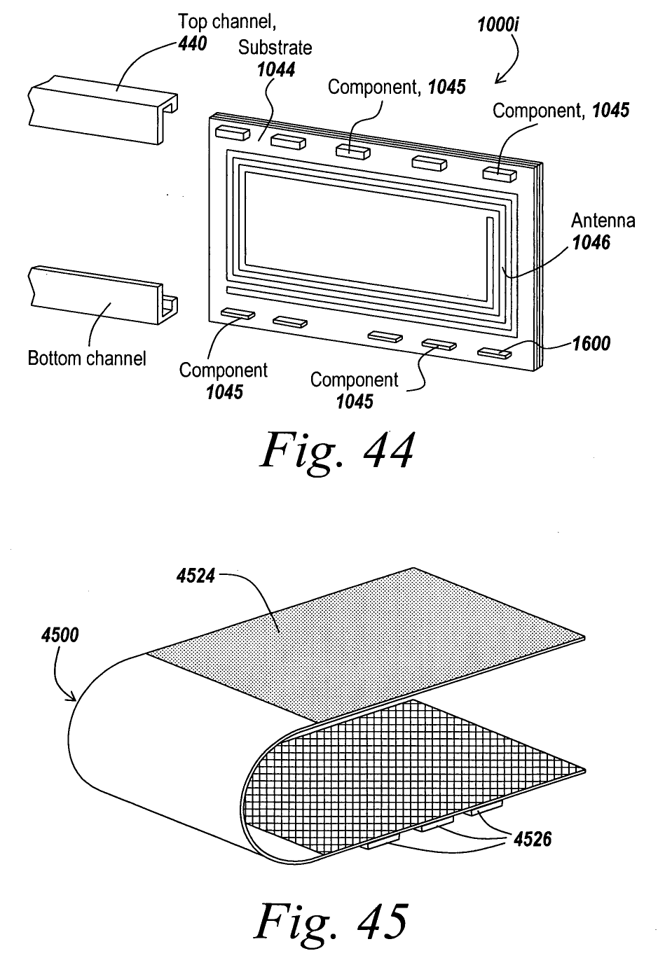

According to another embodiment of the invention, the backplane layer substrate and the display medium layer/substrate can be manufactured from one layer that is bent or folded over, thereby appearing to form a single layer 4500, comprising a display portion 4524 and a backplane portion 4526, as shown in FIG. 45. The components are then placed on the opposite side of the backplane.

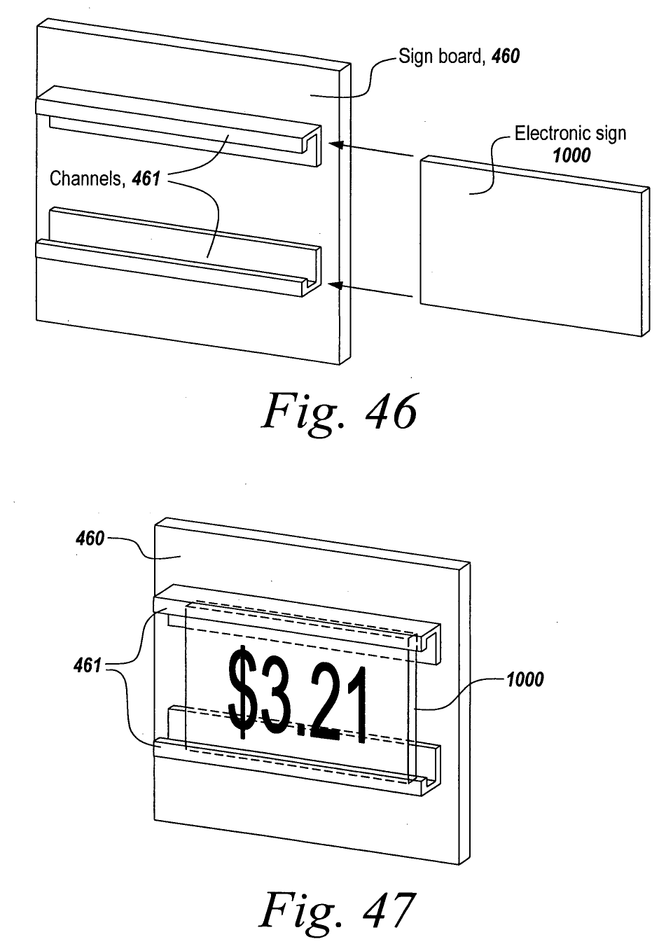

FIG. 46 shows an electronic sign 1000 about to be inserted into a channel 461 of a sign board 460. The sign board 460 can have multiple channels. Each channel can have its own electronic sign. The electronic sign can be mixed and matched within a channel and/or between multiple channels with conventional sign cards, such as those depicted in FIGS. 1-3, which may be composed of paper cardboard or plastic.

FIG. 47 shows an electronic sign 1000 of an illustrative embodiment of the invention after it has been inserted in a channel 461. In this illustrative example, the electronic sign 1000 is displaying the price of $3.21. The prices or message displayed can be changed further based on various real time conditions defined by the company. The conditions include, but are not limited to, on-hand stock, time of day, year, season, promotion, rate of selling, alternative product, priorities, price, and other suitable conditions.

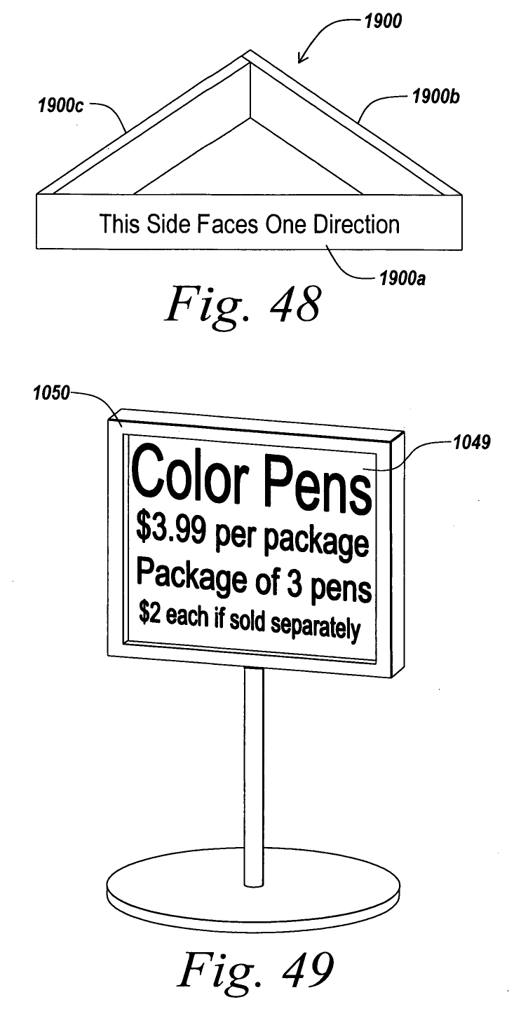

FIG. 48 depicts an electronic sign 1900 can have a polygon shape. In this embodiment there are multiple facets 1900a, 1900b, 1900c of an electronic sign, each with its own set of electronic components or sharing a common subset of electronic components that can be used to display the same and/or different message or price on each facet. In this way, the electronic sign 1900 can be visible from every direction.

In one embodiment, an electronic sign of the present invention can have a display layer in front and back. In this manner, for example, when the electronic sign is hanging, the same or a different message or price can be displayed at the same time on either side of the electronic sign. A sign board can have multiple channels on a side thereby requiring an electronic sign for each channel.

Exemplary embodiments can also allow the electronic sign of the illustrative embodiments of the invention to be used on the end caps of aisles in retail stores.

FIG. 49 shows an electronic sign 1049 placed inside a frame 1050 and advertising pens.

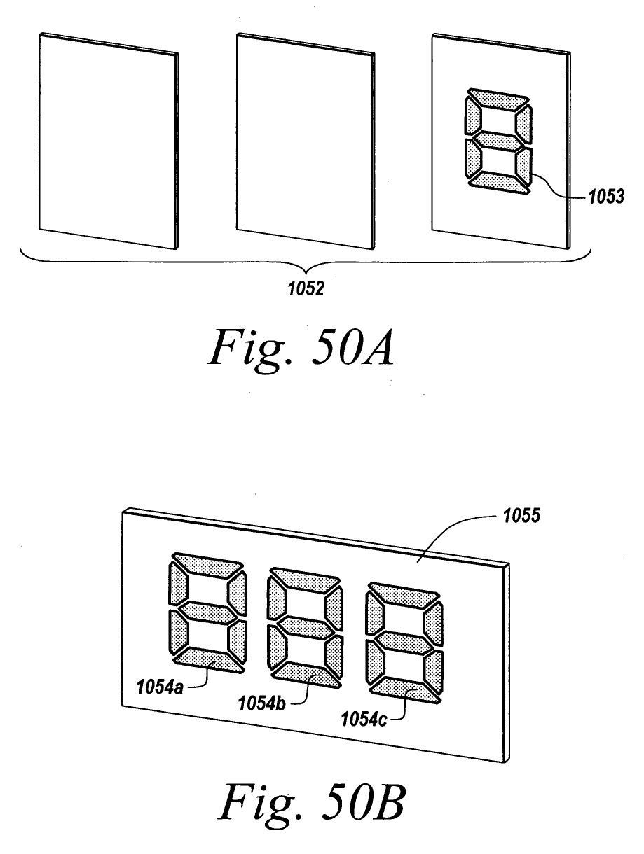

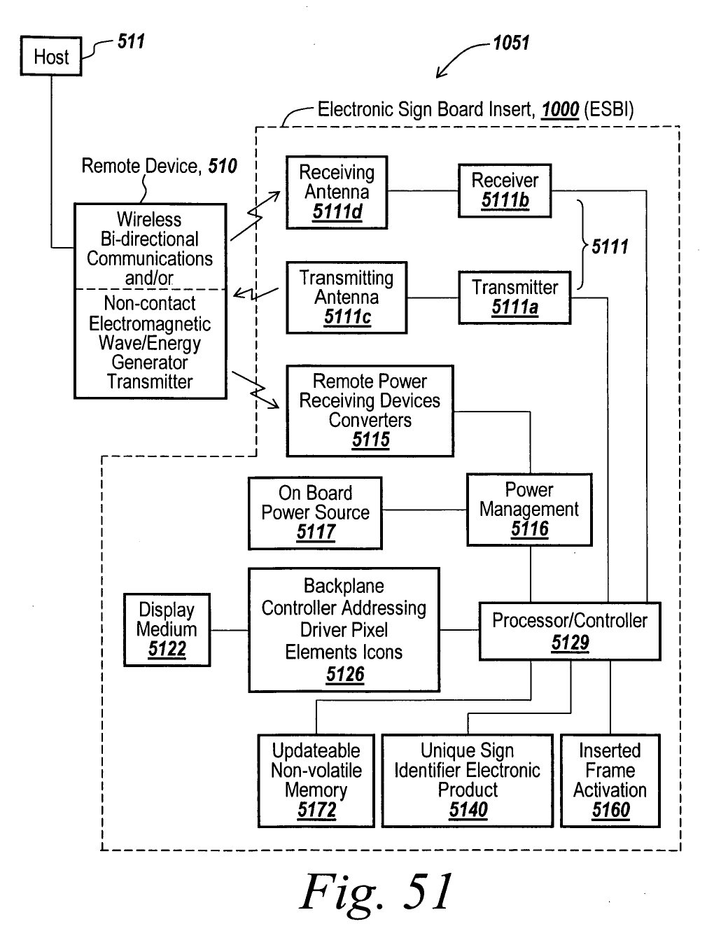

FIG. 50A shows a single character wide electronic sign 1052 displaying information that comprises a single digit 1053 according to one embodiment of the invention.

FIG. 50B shows an electronic sign 1055 with multiple digits 1054a, 1054b, 1054c on a single electronic sign according to one embodiment of the invention.

Different embodiments of this invention can/will/may use different combination of various features and functions listed in this specification.

In one embodiment, the power for an electronic sign can come exclusively from on board power sources, battery (thin film, chemical, printed, gel, traditional cell, organic, inorganic based), storage capacitor and/or solar cell. Alternatively, the power for an electronic sign can come exclusively from off-board sources, electromagnetic means (inductive, capacitance, photon, white noise, ambient electronic signals, lighting, store lighting, solar cells, near field, far field). The power for an electronic sign can come from any combination listed above of on-board or off-board or from another source known to one in the art.

The linear, logic and non-linear components can be fabricated/manufactured, assembled using any process known by one in the art. These include but are not limited to deposition, printing, injecting, inserting, molding, flip chip, organic printing, chemical deposition, chemical vapor deposition.

Display material can also be, Gyricon, cholesteric polymer dispersed liquid crystal, liquid crystal, micro encapsulated electrophoretic, electrophoretic in cells or microcups. The electrophoretic particles can be any color, black or white. The electrophoretic particles can be in a fluid of any color including clear. Electrophoretic particles of different colors can coexist in the fluid. The display material can be of a bi-stable non-volatile type, or can alternatively be of a volatile type, such as liquid crystal, plasma display, mirrors, light emitting diodes, organic light emitting diodes.

Displays can be black and white, gray scale, full color, contrasting two colors that are different in different portion/zones of the display.

In one embodiment, the electronic sign can be part of a system that includes at least one electronic sign board insert and at least one remote device. Referring to FIG. 51, a remote device 510 has bi-directional communication with an electronic sign board insert 1000 via wireless signal. The remote device(s) can communicate with one or more hosts 511 via wired or wireless connection.

The communication between the remote device 510 and electronic label 1000 can occur using standard protocols. One of several possible protocols is the EPC GEN 2 communication protocol. The ESBI can, among other things, be configured to look like a GEN 2 RFID tag. Communication can occur over a mesh network.

The remote device 510 can be a hand-held reader/interrogator/writer carried by an individual, and/or it can be part of a mobile cart that is pre-programmed or follows a path around the store or antenna at fixed locations. Alternatively, the remote device can be another electronic label, or a plurality of electronics label that communicate with each other. Examples of some possible fixed locations are ceiling mounted, embedded/mounted in ceiling tile, embedded in floor tile, on/part of shelving, merchandising fixtures, supported on strategically placed poles or slender wired loops/antennas on or near shelving.

The electronic sign 1000 can include button (not shown) that users or store clerks push to change information display.

The electronic sign can include chips and other solid state devices that make sounds.

FIG. 51 is a functional block diagram showing components of an illustrative electronic sign system 1051. The system as envisioned by this invention which includes one or more electronic signs and one or more remote devices. The “system” communicates with one or more external hosts. The electronic sign can include a transceiver 5111, which may comprise a separate transmitter 5111a and receiver 5111b, each having a dedicated antenna 5111c, 5111d, respectively. A power management module for managing power for the electronic sign 1000 includes a power management component 5116, a remote power receiving device 5115 and/or an on-board power source 5117. A processor/controller 5129 is included which communicates and controls the components. A display medium 5122 and backplane 5126, such as described above, are also included, as well as updatable non-volatile memory 5132. In addition, a unique identifier component 5140 is capable of sending out a unique identifier for the sign 1000. The sign may periodically send the unique identifier, or send the identifier out upon request. A component 5160 for sensing and transmitting information to the processor regarding the location of the sign, such as if the sign is properly inserted in an insertion region, may also be included.

Communication between the remote device 510 and a host 511 can occur via a wired and a wireless means and include mechanisms such as wide area network, local area network, private network, the internet, world-wide web, and any other broadband mechanism Wifi, cable TV, 802.11, mesh networks, cell phones, satellites phones, etc.

Embodiments can cover the methods used to implant the features and functions of an electronic sign and/or system containing one or a plurality of electronic signs.

For example, in one embodiment, an electronic sign 1000 may proactively communicate with a remote device 510 and/or another electronic sign via mesh networking. The use of electronic signs that can communicate with each other and/or a remote device enables proactive advertising. In addition, multiple electronic signs can coordinate between themselves to provide related messages, or have each sign provide a portion of a whole message created by the plurality of signs. For example, a grouping of electronic signs manufactured in accordance with the teachings of the invention may be capable of wirelessly communicating with each other and/or other devices. Each electronic sign in the group may represent a single digit, letter, character, icon or canned message, such that when the signs are placed next to each other, for example in a sign holder designed to hold multiple sign cards, a price or other information constructed using multiple signs can be displayed. Examples of applications include displaying a price of gasoline, cigarettes or the amount of a prize for a lottery drawings.

Embodiments of electronic signs discussed herein can be rigid, while other embodiments of electronic signs discussed herein can be flexible, malleable, etc.

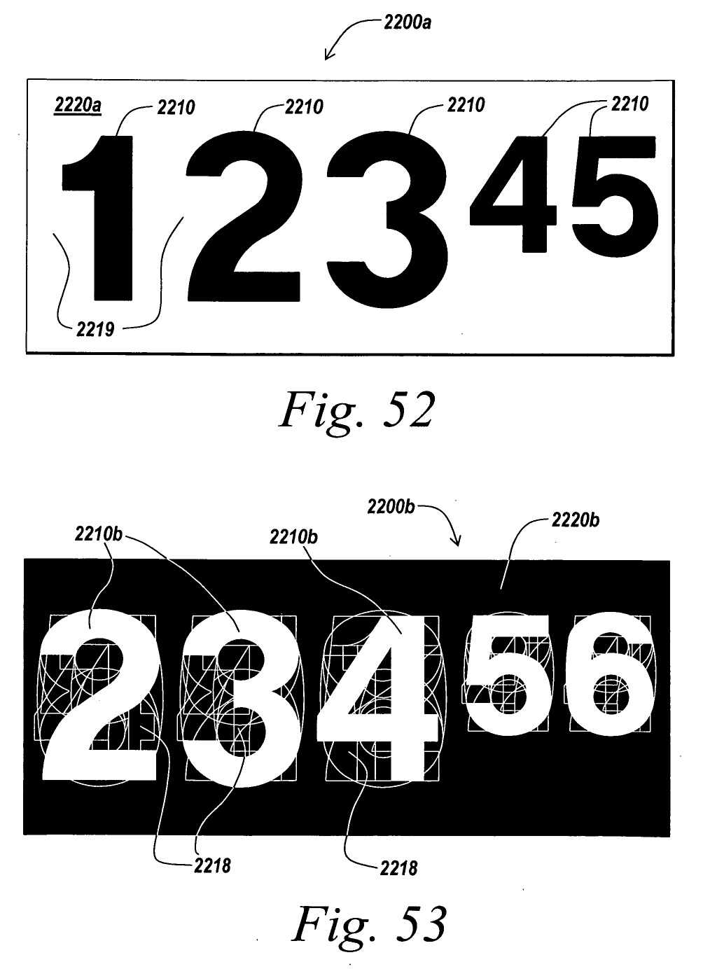

FIG. 52 depicts a picture of a front side of an exemplary embodiment of an electronic sign insert 2200a. The electronic sign insert can display glyphs 2210a on a background 2220a. Glyphs 2210a are composed of related font regions, as discussed herein in relation to FIG. 34. Glyphs 2210a have a selected type face at a select size and in a selected style. Glyphs 2210a displayed by the electronic sign insert 2200a can be darker than the background to provide a contrast between glyphs 2210a and background 2220a to allow glyphs 2210a to be easily readable. In one implementation, glyphs 2210a may be black and the background 2220a can be grey or white. In other implementations glyphs 2210a and the background 2220a can each be any other color. In addition, glyphs 2210a can each have different colors. The non-activated regions, for example, 2219, do not create the display.

FIG. 53 depicts another picture of a front side of an exemplary embodiment of an electronic sign insert 2200b. The electronic sign insert 2200b can display glyphs 2210b on a background 2220b. Glyphs 2210b have a selected type face at a select size and in a selected style. Again, glyphs 2210b are composed of related font regions, as discussed herein in relation to FIG. 34. Glyphs 2210b displayed by the electronic sign insert 2200b can be lighter than the background to provide a contrast between glyphs 2210b and background 2220b to allow glyphs 2210b to be easily readable. In one implementation, glyphs 2210b can be white or grey and the background 2220b can be black. In other implementations, glyphs 2210b and the background 2220b can each be any other color. In addition, glyphs 2210b can each have different colors. The electronic sign insert 2200b can be the same as electronic sign insert 2200a such that a single electronic sign insert can be provided that has the properties of both electronic signs 2200a and 2200b. The non-activated regions, for example, 2218, do not create the display, but can be addressed to change the display, if desired.

FIG. 54 depicts a picture of a backside of an exemplary embodiment of an electronic sign insert 2300. The electronic sign insert 2300 may be the same as the electronic sign 2200a and/or 2200b. In this example, the electronic sign insert includes circuitry for controlling the display on the front side of electronic sign insert (e.g., the front sides depicted in FIGS. 52-53). For example, the circuitry is operable to update or change which glyphs (e.g., 2210a, 2210b) are displayed. Circuitry may control electrodes that are associated with the related font regions to display numerous glyphs such as numeric symbols, alphanumeric symbols or any other symbols or shapes. The electronic sign insert 2300 can include a battery 2320 for supplying power to the circuitry to enable changing or updating the display on the front side of the electronic sign insert, which may be represented by the front sides depicted in FIGS. 52 and 53. The circuitry can also include one or more buses 2330 for transmitting and receiving electronic signals that may control the appearance of the display on the front side. In the present example, buses 2330 are represented by flex connectors, however, buses may be implemented in any manner suitable for passing electronic signals. For example, buses can be provided as traces in a circuit board, such as a PCB. In addition, the circuitry can be provided using multiple substrate layers in a circuit board. Each substrate layer can include at least one electrode that can be used to activate electronic ink to change or update glyphs (e.g., 2210a, 2210b from FIGS. 52 and 53) displayed on the front side.

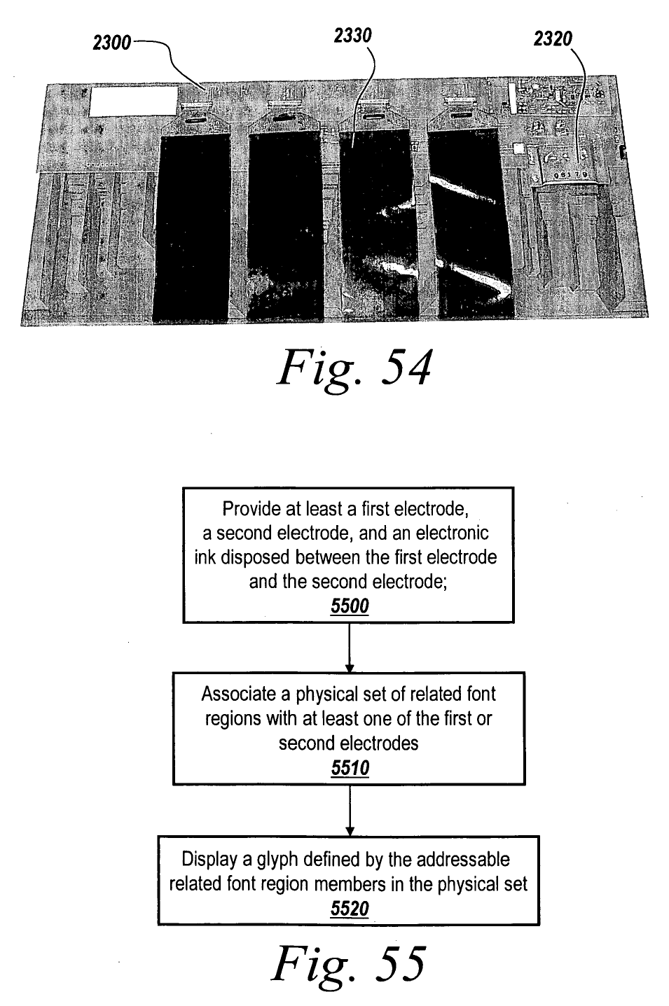

FIG. 55 is an exemplary flow diagram for illustrating displaying information with an electronic sign insert described herein. To begin an electronic sign insert is provide that includes at least a first electrode, a second electrode and a bi stable display medium, such as an electronic ink that is disposed between the first (e.g., common electrode) and second electrode (e.g., a layer of a backplane) (step 5500). The bi stable display medium can be any bi stable display medium described herein or their equivalents that are suitable for displaying glyphs when a power source is not present or when a power source is present.

A physical set of related font regions is associated with at least one of the first or second electrodes (step 5510). Each font region member of the physical set is addressable via at least one of the first or second electrodes to activate the electronic ink. The related font regions can vary in size and shape and may or may not overlap. In one embodiment, each physical set may include approximately 124 related font regions. The number of related font regions can be determined such that a minimum number of related font regions are used to emulate a selected font having a selected type, size and style. In some instances, more related font regions may used or required. In other instances, fewer related font regions may be used or required.

At least one glyph is displayed by the electronic sign insert where the glyph is defined by the addressable related font region members in the physical set (step 5520). The glyph can have a selected type face at a selected size and a selected style. For example, the glyph can have a type face of Helvetica, Courier New, Arial, Time New Roman, etc., and can have a style, such as bold, italicized, underlined, etc.

Embodiments also enable store-wide or multi-store configurations of electronic signs. For example, multiple electronic signs may be placed throughout a store or multiple stores (e.g., a retail chain of stores). The electronic signs can be used to convey information to customers who visit the stores, such as a price, a sale, a message, or any other information. The stores can change, update or refresh the display of the electronic signs individually or collectively. Allowing the stores to update the electronic signs collectively allows the stores to maintain a uniform appearance and reduces the amount of time and labor that would be required as compared to manually updating each sign. A central location can exist that implements the updates for stores in a geographical region. Since the electronic signs can have unique identifiers, the stores can update only the electronic signs that it desires to update. The central location or independent stores can update the electronic signs by communicating with the electronic signs. After the store updates the electronic signs, the glyphs displayed on the electronic signs can be changed, updated or refreshed.

The figures depicted herein are not meant to be limiting and are merely illustrative. Further, the size of the various components, elements, electronic signs, etc depicted in the figures are not meant to indicate an actual size of the components, elements, etc.

It will also be recognized by one skilled in the art that embodiments of the electronic signs may be enclosed or other wise contained in a housing or framing or that that embodiments of the electronic signs may not include a housing or framing.

What is claimed:

1. An electronic display system suitable for displaying information, said system comprising:
a first electrode;
a second electrode;
a bi-stable display medium between the first electrode and the second electrode;
a physical set of related font regions associated with the first and second electrodes for providing a selected type face at a selected size, wherein each font region member of the physical set is addressable via at least one of the first or second electrodes to activate the bi-stable display medium to display a glyph defined by the addressable related font region members in the physical set.

2. The electronic display system of claim 1, wherein two or more of the related font region members in the physical set vary in at least one of size or shape.

3. The electronic display system of claim 1 further comprising:
a battery to provide a power source for activating at least one of the first or second electrodes.

4. The electronic display system of claim 1, wherein the physical set of font regions provides the selected type with a selected style.

5. The electronic display system of claim 1 further comprising:
a sensor for sensing a feature of the electronic display system.

6. The electronic display system of claim 5, wherein the sensor senses whether the electronic display system is inserted in or in proximity of an insertion area.

7. The electronic display system of claim 1, further comprising a processor for controlling operation of the electronic display system, wherein said processors utilizes one or combination of: internally stored information, internally generated information, information received from an external device or information received from another electronic display system.

8. The electronic display system of claim 7, further comprising a sensor for sensing a feature of the electronic display system, wherein the processor controls the operation of the electronic display system based on the sensed feature.

9. The electronic display system of claim 7, wherein the processor is programmed to enable communication with another electronic display system or another device in a mesh networking protocol.

10. The electronic display system of claim 7, wherein the electronic display system is configured to transmit or receive a unique identifier for the electronic display system.

11. The electronic display system of claim 1, further comprising a backplane having a first layer containing a first subset of the physical set of related font regions and a second layer containing a second subset of the physical set of related font regions, wherein the first layer and second layer are stacked together, such that the first subset of the physical set of related font regions overlays the second subset of the physical set of related font regions.

12. The electronic display system of claim 1, further comprising a sign holder having an insertion area for receiving the electronic display system.

13. A backplane for an electronic sign, comprising:
a first layer containing a first pattern of font regions; and
a second layer containing a second pattern of font regions, wherein the first layer and second layer are stacked together, such that the first pattern overlays the second pattern.

14. The backplane of claim 13, wherein the first layer and the second layer further comprise one of electrodes, transistors and combinations thereof.

15. The backplane of claim 13, wherein the first layer has a plurality of traces patterned in a radius and arc pixel addressing scheme with electrodes at intersections of the traces and having a first orientation.

16. The backplane of claim 15, wherein the second layer has plurality of traces patterned in a radius and arc pixel addressing scheme with electrodes at intersections of the traces and having a second orientation.

17. The backplane of claim 15, further comprising a third layer stacked on the first layer and second layer.

18. The backplane of claim 15, wherein a central point of the traces in the first layer is located in a different corner of the backplane.

19. The backplane of claim 13, wherein the pattern on the first layer represents a first glyph in a first font and the pattern on the second layer represents a second glyph in the first font.

20. The backplane of claim 13, wherein the patterns of font regions create glyphs having a first size in a first region of the backplane and a second size in a second region of the backplane.

21. A system for displaying information, comprising:
a first electronic sign comprising an electrode layer, a backplane containing a pattern of addressable font regions, a bi-stable display medium between the backplane and electrode layer and a processor; and
a second electronic sign comprising an electrode layer, a backplane containing a pattern of addressable font regions, a bi-stable display medium between the backplane and electrode layer and a processor, wherein the first electronic sign communicates with the second electronic sign.

22. The system of claim 21, wherein the second electronic sign communicates with the first electronic sign via mesh networking.

23. The system of claim 21, wherein the first electronic sign transmits a unique identifier for the first electronic sign to the second electronic sign.

24. A method of updating information displayed on an electronic sign, the method comprising:
providing a plurality of electronic signs in at least one store;
displaying information with the plurality of electronic signs;
updating at least a subset of the plurality of electronic signs in the at least one store to change information displayed on the subset of signs, wherein each of the subset signs is uniquely identified, the updating performed remotely to the subset of signs and being based the identification of at least one of the signs in the subset.

25. The method of claim 24, wherein:
each electronic sign comprises an electrode layer, a backplane containing a physical set of related font regions for providing a selected type face at a selected size, a bi-stable display medium between the backplane and electrode layer and a processor, and,
each font region member of the physical set is addressable to activate the bi-stable display medium to display a glyph defined by the addressable related font region members in the physical set.
